(19) United States
(12) Patent Application Publication
(10) Pub. No.: US 2023/0147144 A1
(43) Pub. Date: May 11, 2023

(54) SAFETY SYSTEM AND METHOD FOR VEHICLES AND VEHICLE USERS

(71) Applicants: UNIVERSIDAD DE LOS ANDES, Bogota (CO); PROTRAFFIC SAS, Bogota (CO)

(72) Inventors: Alba AVILA, Bogota (CO); Javier Leonardo CASTELLANOS CRUZ, Bogota (CO); Juan Pablo OVIEDO PERDOMO, Bogota (CO); Mario Andres VARON FORERO, Bogota (CO); Zulay VILLABONA PARRA, Bogota (CO); Jheyson Fabian VILLAVISAN BUITRAGO, Sur Bogota (CO)

(21) Appl. No.: 17/905,357

(22) PCT Filed: Jun. 17, 2021
(86) PCT No.: PCT/IB2021/055372

§ 371 Date: Dec. 14, 2022

(30) Foreign Application Priority Data
Jun. 17, 2020 (CO) NC2020/0007401

(51) Int. Cl. A42B 3/04; A42B 3/30; B60R 25/045; B60R 25/104; B60R 25/10

(52) U.S. Cl. CPC A42B 3/0406; A42B 3/303; B60R 25/045; B60R 25/104; B60R 25/1004; B60R 2025/1016

(57) ABSTRACT

The present invention relates to security systems and methods for vehicles and/or vehicle users that prevent the theft of vehicles, and/or that guarantee the security of the vehicle user. In order to achieve the above, the system of the present invention has an enabling system that controls the ignition of the vehicle, and/or a device for helmets intended for the monitoring of the security of the user, and makes it possible to determine, for example, whether the user is wearing the helmet and is using the same correctly, or whether the vehicle user has suffered an impact. Specifically, the system of the present invention has an interactive system (mobile device) associated with the user which, depending on the need, signals the enabling system to enable the vehicle ignition, provided that at least one condition is fulfilled, where a condition may be that the interactive system is close to the enabling system and/or emits an alert message to the external device of a third party if any novelty is detected in the helmet device.

### FIELD OF THE INVENTION

The present invention relates to security systems and methods for vehicles and users which enables evaluation of conditions associated with the vehicle or the security of the user of the vehicle so as to perform activities such as enabling the ignition or the sending of messages to third parties. In particular, the present invention relates to security systems and methods for vehicles wherein the user can use a protective helmet.

### PRIOR ART

The prior art discloses security systems of vehicles in the documents US 20170158107 A1, EP 1590230 B1, U.S. Pat. No. 9,399,398 B1, WO2019/053757 A1 and US 2005/0248444 A1.

The document US 20170158107 A1 discloses a system and method promoting the correct use of protective helmets. The helmet disclosed includes a sensor in order to determine if worn correctly and is in communication with the vehicle to enable or restrict the operation thereof depending on whether the condition is completed satisfactorily or not. Specifically, the sensor includes a wireless system of communication between the helmet and the motorcycle, as well as an accelerometer which determines the position in which the helmet is disposed. Also, this document discloses a capacitive sensor which detects the contact or proximity of the skin of the driver to the protective helmet. This document indicates that it is possible to determine a range which enables knowing if the helmet is being worn correctly.

Additionally, this document discloses a temperature sensor which is employed to determine the temperature of the body with the object of ensuring that the helmet is located correctly. The apparatus also employs an optical sensor and a sensor which measures the continuity of the voltage; in the case of the first of these the optical interference indicates that the helmet is disposed in the correct position, and the continuity of the latter indicates that the helmet is buckled correctly. This document also discloses a sensor for the vehicle, which comprises a GPS sensor, an accelerometer, an RPM sensor and a wheel velocity sensor. This device controls the ignition of the vehicle via the electrical system thereof. That sensor is activated or deactivated depending on the signals sent by the sensor of the helmet (i.e., If it is disposed correctly).

Nevertheless, the document US20170158107A1 lacks the disclosure of a sensor of the helmet which communicates with any external device distinct from that which controls the ignition of the vehicle, severely limiting the diagnosis, configuration and later use thereof, as well as the correct understanding of these parameters on the part of the final user. Moreover, the document US20170158107A1 does not disclose how to mutually communicate voice and audio from the device in the helmet with other devices. Moreover, the document US20170158107A1 does not disclose how to automatically notify a third-party in the event of an accident involving the motorcyclist. Finally, the document US20170158107A1 does not disclose any element which impedes the theft of vehicles.

On the other hand, the document EP1590230B1 discloses a method and system to control two-wheeled vehicles (i.e. motorcycles, motor scooters and motorized bicycles) and impedes the motion thereof when the driver makes mistakes in the driving of the vehicle. The behavior which is characterized by the device is the lack of use of a protective helmet or its use without an adequate safety buckle or the incorrect use thereof. Moreover, there is identification and penalization of other behavior (i.e. methods) such as the mounting of a second person when that is not permitted, the dangerous handling of the vehicle during the trajectory, driving too fast, driving under the influence, among other behavior. This system comprises four units, the first unit of these is an electrical control unit which affects the ignition of vehicles. The second unit is a device which is installed in the protective helmet of the driver. The third unit is a device which is a jacket with an airbag which protects the upper part of the chest and the neck of the driver. Finally, there is a fourth unit which is a device with the form and function of a remote control to control the other three units. The functioning of the system is controlled by the signals emitted by the second unit. In particular, if this is activated by any one of the previously characterized behaviors, a signal would be transmitted such that the first unit severs or impedes the electrical current to the ignition system of the vehicle.

Nevertheless, the document EP lacks the disclosure of a sensor of the helmet which communicates with any distinct external device other than that which controls the ignition of the vehicle, severely limiting the diagnosis, configuration and later use thereof, as well as the correct understanding of these parameters on the part of the final user. Moreover, the document EP1590230B1 does not disclose how to mutually communicate voice and audio from the device in the helmet with other devices. Moreover, the document EP1590230B1 does not disclose how to automatically notify a third-party in the event of an accident involving the motorcyclist. Finally, the document EP does not disclose any element which impedes the theft of vehicles.

The document U.S. Pat. No. 9,399,398 B1 discloses a system and method to promote the use of the protection kit by the drivers. The helmet contains a microprocessor and some sensors to determine if the protective helmet is worn correctly. The helmet communicates with a device installed in the vehicle to permit operation or disablement depending on whether the helmet is used correctly. The operation is restricted in motorized vehicles, whereas the resistance of the vehicle is incremented in vehicles operated by people (i.e bicycles). Some of the sensors which can be employed to detect the correct position of the helmet include a capacitive sensor, an accelerometer, an optical sensor or voltage continuity meter to identify that the helmet is buckled correctly. The device found in the vehicle detects the signal of the helmet and limits the velocity, without switching it off.

Nevertheless, the document U.S. Pat. No. 9,399,398 B1 lacks the disclosure of a sensor of the helmet which communicates with any distinct external device other than that which controls the ignition of the vehicle, severely limiting the diagnosis, configuration and later use thereof, as well as the correct understanding of these parameters on the part of the final user. Moreover, the document U.S. Pat. No. 9,399,398 B1 does not disclose how to mutually communicate voice and audio from the device in the helmet with other devices. Moreover, the document U.S. Pat. No. 9,399,398 B1 does not disclose how to automatically notify a third-party in the event of an accident involving the motorcyclist. Finally, the document U.S. Pat. No. 9,399,398 B1 does not disclose any element which impedes the theft of vehicles.

In the case of the document WO2019/053757 A1 there is the disclosure of a helmet with security functions designed to be used by drivers and users in both vehicles and in other types of activities (i.e sports). The helmet is equipped with an electronic device comprised of an electronic circuit with the processor, communications system, GPS, gyroscopes, SIM, accelerometers, audio and speech systems, a movement sensor, an RFID reader, an internet and an external device connection, as well as an array of LEDs. The helmet is designed to visualize the activities of braking, the changes of direction during the execution of sporting activities, and also records the actions performed by the user or if the user suffers an accident. Finally, the information collected is sent to a central server.

Nevertheless, the document WO 2019/053757 A1 does not disclose that the electronic device be portable, nor that an adaption to any helmet is enabled. Thus, the electronic device does not determine if the helmet is positioned correctly and buckled correctly. Finally, the device does not resolve the problem of theft of vehicles.

In the case of document US 2005/0248444 A1 there is the disclosure of an apparatus which includes a first device in the vehicle with the capacity of controlling one or more systems. This first device generates or transmits a first signal to control the system. This first signal is generated in response to a second signal, generated or transmitted by a second remote device installed in a vehicle. This second signal is generated in response to a third remote signal which is generated from the Internet. This apparatus prevents the theft of vehicles wherein the first device is installed. This patent, nevertheless, does not resolve the problem of guaranteeing a verification means in respect of external devices since the signal is only activated from the device. Thus, the patent does not resolve the problem of disabling the first device using analog mechanisms or “backdoors”.

As a result, the state of the art discloses different security devices and methods in vehicles. Nevertheless, none of these devices or methods disclose the existence of communication between a device associated with the user of the vehicle to at least one external element, wherein the external element has control over the ignition of the vehicle, such that the avoidance of theft of the vehicle is enabled. In the same manner, none of the devices or methods in the prior art disclose communication of the device associated with the user of the vehicle to the helmet of the user of the vehicle, so as to improve the security of the user of the vehicle.

### BRIEF DESCRIPTION OF THE INVENTION

In one embodiment of the present invention there is a security system for vehicles which enables the ignition of the vehicle via controlled stimuli or conditions which are external to the same. The security system for vehicles comprises an enablement system and an interaction system. In this embodiment, the enablement system enables an ignition device of the vehicle when the interactions system sends some valid access data thereto.

In another embodiment, the present invention comprises a security system for vehicles and users of vehicles which comprises a device which is disposed in any protective helmet that the user of the vehicle employs, thus, the system of the present invention has an enablement system and an interaction system. The device for helmets measures a plurality of conditions of the helmet, for example, if the helmet is positioned properly, in other words, if it is buckled correctly or not. If the helmet is buckled correctly, the enablement system enables the ignition device of the vehicle when the interaction system sends some valid access data thereto and when the device for helmets sends some valid status data of the helmet.

In another embodiment, the present invention comprises a security system for users of vehicles which comprises a device for helmets and an interaction system, in which the device for helmets enables measurement of some conditions of the helmet such that a determination as to whether the user of the helmet has suffered some accident which generates an emergency, and in the event that an emergency is detected, the interaction system generates a command to issue an alert to a third party.

In another embodiment, the present invention refers to a security method for vehicles, which in general comprises the steps of: a) generating a pairing signal when pairing and communication links are established between the communications and pairing module of an interaction system, and a communications and pairing module of an enablement system, and sends that pairing signal to a computation unit of the enablement system; b) sending some predetermined pairing data, which the computation unit accesses, to the verification module of the interaction system via the pairing and communication link, on receipt of the pairing signal; c) acquiring some configuration data, by means of a data registration module, from a data registry; d) acquiring some validated access data at the verification module, by means of a verification algorithm which takes into account the predetermined configuration data and the pairing data; e) sending the validated access data to the computation unit via the pairing and communication link; f) generating an activation signal at the computation unit of the enablement system, on receipt of the validated access data; and g) enabling the ignition device of the vehicle, by transmitting the activation signal to an activator of the enablement system, which is connected to the ignition device.

In another aspect of the present invention, there is a security method for vehicles and users of helmets which comprises: A) generating a pairing signal (2-2) in the communications and pairing module (125) of an enablement system (12) when a pairing and communication link is established (1-2-1) between the communications and pairing module (125) and the communications and pairing module (115) of an interaction system (11) and sending that generated pairing signal (2-2) to a computation unit (121) of the enablement system (12); B) sending some predetermined pairing data (2-3) accessed by the computation unit (121) to a verification module (111) of the interaction system (11) via the pairing and communication link (1-2-1) on receipt of the pairing signal (2-2); C) acquiring some configuration data (1-5) from a data registry (1-9) by means of the data registration module (112); D) acquiring at the verification module (111) some validated access data (1-1) by means of a verification algorithm which takes into account the configuration data (1-5) generated by the data registration module (112) and the predetermined pairing data (2-3); E) acquiring some data of the state of the helmet (3-1) or a signal of the status of the helmet at a sensor (133) of the device for the helmets (13); F) acquiring at the computation unit (131) some validated data of the state of the helmet (3-3) by means of a verification algorithm which takes into account the state of the helmet data (3-1) and some predetermined data of the state of the helmet (24) which the computation unit (131) accesses and obtain by means of the computation unit (131) the state of the helmet data (3-1) using a signal processing method which inputs the status of the helmet signal; G) generating a pairing and communication link (2-3-1) between the communications and pairing module (125) and the communications and pairing module (135) of the device for the helmet (13) or a pairing and communication link (1-3-1) between the communications and pairing module (135) and the communications and pairing module (115); H) sending the validated access data (1-1) via the pairing and communication link (1-2-1) to the computation unit (121) and sending the validated state of the helmet data (3-3) to the computation unit (121), wherein when the validated state of the helmet data (3-3) are obtained by the verification module (111) and sent to the computation unit (121) via the pairing and communication link (1-2-1), or when the validated state of the helmet data (3-3) are obtained by the computation unit (131), they are sent to the computation unit (121), via the pairing and communication link (1-3-1); I) generating an activation signal (2-1) at the computation unit (121) from the validated access data (1-1) and the validated state of the helmet data (3-3); and J) enabling the ignition device (15) of the vehicle by transmitting the activation signal (2-1) to an activator (127) of the enablement system (12) which is connected to the ignition device (15); whereat the validated state of the helmet data (3-3) obtained by the verification module (111) are obtained via a verification algorithm which takes into account the state of the helmet data (3-1) obtained by the computation unit (131) and sent via the pairing and communication link (1-3-1) to the verification module (111) and some predetermined state of the helmet data (24) accessed via the verification module (111).

Finally, the present invention refers to a security method for users of vehicles, which comprises the following stages: I) acquiring some state of the helmet data (3-1) from the sensor (133) of the device for the helmet (13) or a signal of the status of the helmet; II) acquiring some validated state of the helmet data (3-3) at the computation unit (131) of the device for the helmets (13), by means of a verification algorithm which takes into account the state of the helmet data (3-1) and some predetermined state of the helmet data (24) which the computation unit (131) accesses, or the status of the helmet to data (3-1) using a processing method of signals which input the signal of the status of the helmet; III) generating a pairing and communication link (1-3-1) between the communication and pairing module (115) of the interaction system (11) and the communications and pairing module (135) of the device for the helmets (13); IV) sending the validated state of the helmet data (3-3) and/or the state of the helmet data (3-1) via the pairing and communication link (1-3-1) to a verification module (111) of the interaction system (11); V) generating a command to issue an alert (1-6) in the interaction system (11) based on the validated state of the helmet data (3-3) sent by the device for the helmets (13) and/or generated by the verification module (111) by means of a verification algorithm which takes into account the state of the helmet data (3-1) obtained by the computation unit (131) and some predetermined state of the helmet data (24) accessed via the verification module (111); VI) generating an alert notification (1-7) by means of a generation of alerts module (117) of the interaction system (11) based on a command to issue an alert (1-6); and VII) sending an alert notification (1-7) from the communications and pairing module (115) to the external device (14) of another user.

### BRIEF DESCRIPTION OF THE DRAWINGS

FIG. 1 represents a block diagram of an embodiment of a security system for vehicles which comprises an interaction system and an enablement system.

FIG. 2 represents a block diagram of an embodiment of a security system for vehicles and users which comprises an interaction system, an enablement system and a device for helmets.

FIG. 3 represents a block diagram of an embodiment of a security system for users which comprises an interaction system and a device for helmets.

FIG. 4 represents a schematic drawing of an embodiment of a security system for vehicles and users in which the interaction system is a mobile device, the enablement system is disposed in a motorcycle, and a device for helmets which is disposed in a helmet, and in which the enablement system is disposed in a motorcycle and comprises a computation unit, a storage module, a pairing and communications module, a backup system, an activator and a sensor.

FIG. 5 represents an embodiment of a device for helmets which comprises a computation unit, a storage module, a sensor, a data send-and-receive module, an alert generation module which comprises a button and a voice and audio intercommunication module.

FIG. 6 represents a flowchart of an embodiment of a security method for vehicles.

FIG. 7 represents a flowchart of an embodiment of a method for the disablement of the ignition of a vehicle.

FIG. 8 represents a flow chart of an embodiment of a security method for vehicles and users who use a helmet.

FIG. 9 represents a flow chart of an embodiment of a security method for users of vehicles.

FIG. 10 represents a flow chart of an embodiment of a security method for users of vehicles which comprises a backup system.

### DETAILED DESCRIPTION OF THE INVENTION

The present invention relates to some security systems and some methods for vehicles and drivers, which perform a verification of conditions which enable taking actions, those actions could be enabling the ignition of the vehicle or sending an alert message to a third-party. Thus, the theft of the vehicle is avoided by the present invention having control over the ignition of the vehicle, and additionally the integrity of the user of the vehicle is safeguarded by executing the sending of messages to third parties in the event that the user has an accident which prevents communication by means of the user themselves.

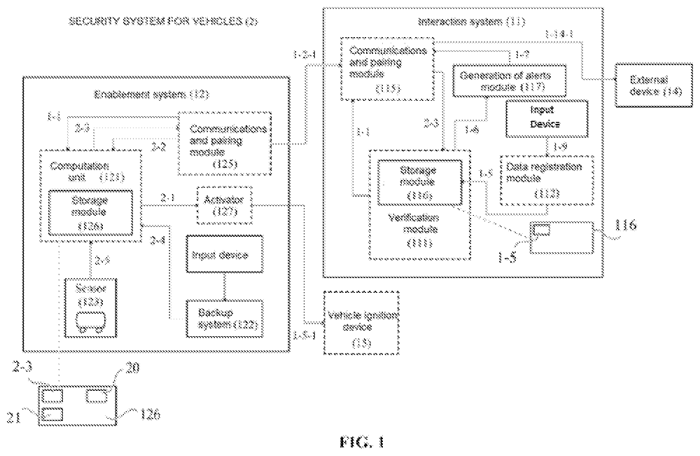

Referring to FIG. 1, in the first embodiment of the invention which is comprised of the elements enclosed in the dotted line boxes, the security system of vehicles (2) comprises:
an enablement system (12) disposed in the vehicle and comprised of:
   a computation unit (121) configured to generate an activation signal (2-1) on receipt of a pairing signal (2-2) and some validated access data (1-1), wherein the computation unit (121) is configured to access some predetermined pairing data (2-3);
   a communications and pairing module (125) connected to the computation unit (121), configured to generate a pairing and communication link (1-2-1) and the pairing signal (2-2), wherein the pairing signal (2-2) is generated on the establishment of the pairing and communication link (1-2-1);
   an activator (127) connected to the computation unit (121) and connected to an ignition device of the vehicle (15), wherein the activator (127) is configured to enable the ignition device of the vehicle (15) on receipt of the activation signal (2-1) from the computation unit (121); and
an interaction system (11) connected to the enablement system (12) and comprised of:
   a communication and pairing module (115) configured to establish communication with the communications and pairing module (125) of the enablement system (12) generating the pairing and communication link (1-2-1) once the link is established;
   a data registration module (112) configured to generate some configuration data (1-5) by means of a data registry (1-9);
   a verification module (111) connected to the communications and pairing module (115) and to the data registration module (112).

In this case, the verification module (111) is configured to generate the validated access data (1-1) by means of a verification algorithm which takes into account the configuration data (1-5) generated by the data registration module (112) and some predetermined pairing data (2-3).

In particular, the predetermined pairing data (2-3) are sent to the interaction system (11) via the pairing and communication link (1-2-1) when the computing unit (121) receives the pairing signal (2-2). Moreover, the validated access data (1-1) are sent to the enablement system (12) via the pairing and communication link (1-2-1).

One technical effect of the security system for vehicles (2) is to prevent a third-party from stealing the vehicle when a security system for vehicles (2) is disposed therein, in so much as the third-party will not be able to start up the vehicle without conforming with the established conditions for the user, for example, the user could set up as a condition that the ignition apparatus of the vehicle (15) could only be enabled in the presence of validated access data (1-1) in the computing unit (121) of the enabling system (12). Nevertheless, the verification module (111) needs to perform a verification to obtain the validated access data, wherein the configuration data (1-5) are compared with the predetermined pairing data (2-3) and the valid access data (1-1) are generated only when they coincide.

In particular, the enablement system (12) of the present invention is charged with enabling the ignition of the vehicle, and as previously mentioned, that enabling system includes the computation unit (121), the communication and pairing module (125) and the activator (127).

On the one hand, the computation unit (121) corresponds to a device which enables processing of data derived from some external element, which could be the interaction system, there is analysis thereat and actions are performed such as the generation of a signal (for example, an activation signal), the generation of data, access to stored data, among other possible actions which could be performed. In a particular embodiment, the computing unit (121) receives the validated access data (1-1) and generates the activation signal (2-1) sent by the activator (127).

In one embodiment of the invention, the computation unit (121) is connected to a storage module (126), and that storage module (126) is a hardware element which can be used to store information or data in a manner which can be accessed by the computing unit. In a particular embodiment, the storage module (126) stores the predetermined pairing data (2-3). In that event, the computing unit (121) accesses the predetermined pairing data (2-3) via the storage module (126).

On the other hand, the communications and pairing module (125) is a hardware element coupled to a computation unit, processing unit, a processing module or a server, which is configured to establish communication via pairing and communication links between one or more computing units or servers to exchange data, commands and/or labels. In the same manner, the communications and pairing module (125) should enable the establishment of pairing between elements; which is to say, the communications and pairing module 125 should be capable of establishing pairing with another element to later effect a linkage between the elements. Specifically, in order to implement the linkage between the interaction system (11) and the enablement system (12), the communications and pairing module (125) is additionally configured to generate a pairing signal (2-2) and to send it to the computing unit (121), this pairing signal (2-2) is generated when the communications and pairing module (125) detects a proximal element, in this case, the verification module (111) performs the verification to confirm if the elements can be linked.

Additionally, the communications and pairing module (125) can be selected from within the group comprised of a communications component with Bluetooth low energy technology, or a communications component with classic Bluetooth technology, Wi-Fi, radio frequency RFID (Radio Frequency Identification), UWB (Ultra Wide Band), IP telephony, GPRS, Konnex or KNX, DMX (Digital MultipleX), WiMax and equivalent wireless communication technologies known to persons skilled in the art and combinations of those listed above which enable the establishment of a pairing and communication link with another device.

The activator (127) is charged with impeding the condition of the vehicle, and it should be understood that the activator (127) is a device which responds to a signal (for example, to an electrical signal or a pneumatic signal) with a physical effect on another device: such as a current, force, contact, movement, among other actions. In this particular case, the activator (127) receives a signal which may be termed an electrical activation signal (2-1), and on receiving that activation signal (2-1), the activator (127) performs a physical action on the ignition device of the vehicle (15).

The ignition of vehicles device (15) should be understood to be any element or device necessary to start up the motor of a vehicle. It is important to note that various devices could exist in a vehicle which are necessary to start up the motor of the vehicle, for example, the ignition of the vehicle devices (15) which can be found in an automobile are an electrical starter system, the ignition system, the gasoline feed system or other ignition devices of vehicles known to persons skilled in the art, as well as combinations of the above.

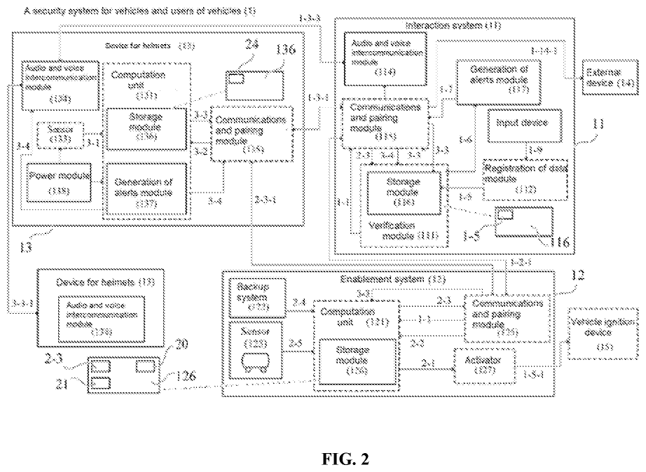

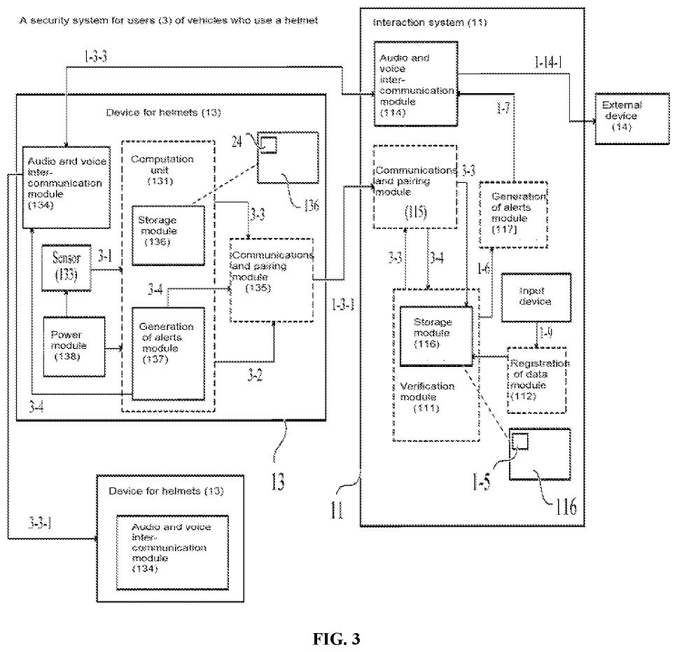

On the other hand, the activator (127) may be selected from among the following technologies: pneumatic, mechanical, electrical (for example, transistors), electromechanical (for example, solenoid valves, electrical relays), hydraulic, or a combination of these. In a particular embodiment, the activator (127) is an electrical relay connected to the electrical ignition of the vehicle, in this case, the electrical relay impedes the electrical current, such that the ignition of the vehicle is impeded. Referring to the FIGS. 2 and 3, the activator (127) is connected by a connection (1-5-1) to the ignition device (15) of the vehicle, this connection depends on the nature of the activator (127), for example, when the activator (127) is a solenoid valve which is disposed at the entrance to the gas tank associated with the vehicle, in this case the connection (1-5-1) is a coupling of the solenoid valve which enables disposition of the entry to the tank. Nevertheless, in the event where the activator (127) is an electrical connection relay (1-5-1), it corresponds to some electrical connections enabling the electrical relay to connect with the ignition circuit of the vehicle.

Meanwhile, the activation signal (2-1) may be selected from an electrical signal (for example, voltage levels, current amplitudes), pneumatic signals, digital signals (for example, a frame of logical bits) or combinations of the above.

In one embodiment of the invention, the enablement system (12) additionally comprises a backup system (122) with an input device, which enables the input of authentication such that the computing unit (121) enables the ignition device (15) of the vehicle. The backup system (122) enables input of authentication via the input device, such that some backup data are generated (2-4) which are sent to the computing unit (121). The computing unit (121) is configured to obtain some validated backup data (20) by means of a verification algorithm which takes into account the backup data (2-4) and some predetermined backup data (21) which the computing unit (121) accesses. In this embodiment, the computing unit (121) is additionally configured to generate the activation signal (2-1) on acquiring the validated backup data (20). One of the technical effects of this is that the ignition of the vehicle by the user is enabled when the interaction system (11) has a defect, such as when there was a theft or when it has been discharged.

The input device of the backup system (122) should be understood to be a device which enables the registration of user data via an interface. In addition, the input device of the backup system (122) may be selected from the group comprised of the knob of a potentiometer, a mechanical encoder with a luminous indicator, a user interface with digital buttons, an interface with mechanical buttons, a mouse, trackball, touchpad, pointing device, joystick, biometric reader or combinations of the above.

In one embodiment of the invention, the predetermined backup data (21) are stored in the storage module (126). In that event, the computing unit (121) accesses the predetermined pairing data (21) via the storage module (126).

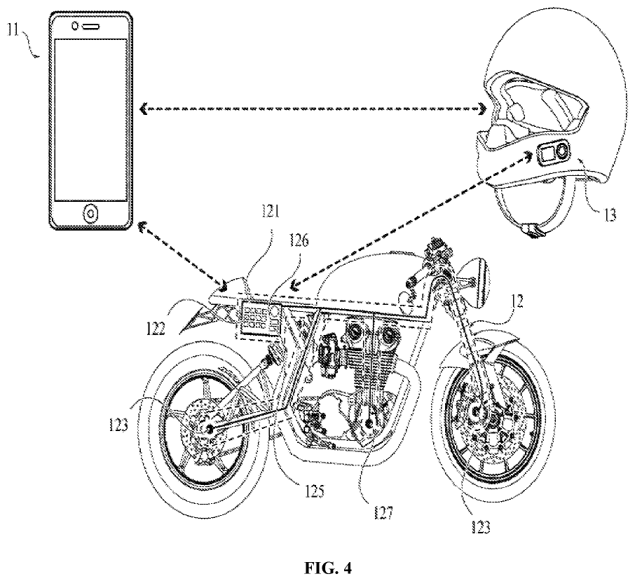

Referring to FIG. 4, in one embodiment of the invention, the enablement system (12) may be disposed in a motorcycle. In that event, the enablement system (12) comprises a casing which houses the computing unit (121) with a storage module 126), and the communications module (125). The enablement system (12) also comprises the backup system (122) which has an input device which, in this embodiment, some buttons for the input of authentication.

Optionally, the enablement system (12) may comprise a sensor (123), which is configured to measure a characteristic of the vehicle wherein the enablement system (12) is disposed. In one embodiment of the invention, the sensor (123) acquires some signals of the vehicle, and this signal of the vehicle is a signal associated with information about a characteristic of the vehicle, which could be the velocity, acceleration or angle. The signals of the vehicle are processed by the computation unit (121) to obtain data of the vehicle (2-5) and these are later sent to the interaction system (11) or are stored in the storage module (126).

Referring to FIGS. 1 and 2, in some embodiments of the system of the present invention, the sensor (123) may have a computation unit which processes the signals of the vehicle associated with the measurements so as to acquire some data of the vehicles (2-5), so as to later send them to the storage module (126).

The sensor (123) may be selected from the group comprised of precision sensors, accelerometers, sensors of the level of gasoline, and other sensors which enable the measurement of a characteristic of the vehicle and equivalents known to persons skilled in the art, as well as combinations of the above.

Continuing with FIG. 4, the sensor (123) is a sensor of the pressure of the tires which enables information on the state of the pressure of the tires of the vehicle, the sensor (123) may be connected to each tire of the vehicle.

In any one of the embodiments of the system of the present invention which comprise the sensor (123), the measurement of a variable related to the dynamics of the vehicle is enabled. In another embodiment, the sensor (123) could be an accelerometer which enables information on the velocity of the vehicle, but it should be understood that the sensor could include sensors of velocity, acceleration, position, inclination and the like. In the embodiment in which the sensor is an accelerometer, the sensor (123) acquires the data of the vehicles (2-5) associated with the velocity and stores them in the storage module (126). In another embodiment which is not illustrated in the figures, the data of the vehicle (2-5) are sent to the interaction system (11) via the pairing and communication link (1-2-1), so that it stores them in the verification module (111), and if so required, sends them to an external device (14).

On the other hand, the interaction system (11) of the present invention is charged with the verification of data which are acquired in the present invention, and in the case of the security system (2) for example, they are some configuration data (1-5) which are generated in the data registration module (112) from the registered data (1-9).

The interaction system (11) may be selected from the group comprised of mobile devices, tablets, computers, or any similar device which enables an interaction between the systems.

Mainly, the verification module (111) is a computation unit, which is to say that the verification module (111) is a device which enables processing of the data derived from an external element, which could be the enablement system, and analyzes them and performs actions which could be the generation of a signal, the generation of data (for example, validated status data (1-1)), the access to stored data, among other actions which may be performed. In one specific embodiment, the verification module (111) is charged with verification of various conditions which are established by the user of the vehicle, for example, in the case of the security system for vehicles (2) the verification module (111) enables verification that the configuration data (1-5), generated by the data registration module (112), coincide with some predetermined access data (2-3) which are sent from the enablement system (12).

In a particular embodiment, the verification module (111) comprises a storage module (116), wherein the storage module (116) is a hardware element which may be employed to store information or data and which may be accessed via the verification module (111).

In another particular embodiment, the interaction system (11) uses block chain technology to establish a security layer protect stored data. This interaction system (11) could interact with the block chain network using call up to generate storage petitions or verification of data or for validation if the enablement system (12) is registered therein.

Additionally, the computation unit (121) and the verification module (111) may be selected from the group comprised of: microcontrollers (for example, PSOC 4BLE), microprocessors, DSCs (Digital Signal Controllers), FPGAs (Field Programmable Gate Arrays), CPLDs (Complex Programmable Logic Devices), ASICs (Application-Specific Integrated Circuits), SoCs (system-on-a-chip), PSoCs (programmable system-on-a-chip), computers, servers, tablets, cellular phone, intelligence cellular phone, signal generators and computation units, processing units or processing modules known to persons skilled in the art, and combinations of the above. In a particular embodiment, the computation unit (121) and the verification module are microcontrollers.

However, the communication and pairing module (115) is a hardware element coupled to a computation unit, processing unit, or processing module or server, which is configured to establish communication via pairing and communication links between one or more computation units or servers to interchange data, commands and/or labels. In the same manner, the communication and pairing module (115) should enable the establishment of pairing between elements; that is to say, the communications and pairing module (115) should be capable of establishing pairing with another element of the same type to later implement links there between.

In one particular embodiment, the communications and pairing module (115) establishes the pairing and communication link (1-2-1) with the communications module (125) of the enablement system (12) when these are found within reach. Later, the communications and pairing module (115) must receive some predetermined pairing data (2-3) to implement the link between the enablement system (12) and the interaction system (11), and these are sent to the verification module (111) which processes this data and determines if the link between these elements is valid. Finally, once the link between the enablement system (12) and the interaction system (11) is established, the communications and pairing module (115 sends validated access data (1-1) to the communications and pairing module (125) of the enablement system (12) via the pairing and communication link (1-2-1).

Additionally, the communications and pairing module (115) can be selected from the group comprised of a communications component with Bluetooth low energy technology, or a communications component with classic Bluetooth technology, Wi-Fi, radio frequency RFID (Radio Frequency Identification), UWB (Ultra Wide Band), IP telephony, GPRS, Konnex or KNX, DMX (Digital MultipleX), WiMax and equivalent wireless communication technologies known to a person skilled in the art and combinations of those listed above which enable the establishment of a pairing and communication link with another device.

The communications and pairing module (115) may be configured from independent modules which perform distinct functions, which could be a pairing module and a communications module and other related modules with communication and pairing functions of devices known to a person skilled in the art. For example, the communications and pairing module (115) configures at least one communications module and one pairing module. In this particular embodiment, the communications module is charged with enabling the communication between elements, whether between the enablement system (12), the interaction system (11) or any other element which desires to interchange data with them, such that the performance of transference of information between devices is enabled. In this particular embodiment, the pairing module is charged with establishing the pairing and communication links between the elements.

On the other hand, the data registration module (112) of the interaction system (11) is a device which enables the registration of user data via an interface. In one particular embodiment, the data registration module (112) receives the registration data (1-9) (for example, a numerical code or a digital fingerprint) from a user and generates some configuration data (1-5) based thereon to be validated by the verification module (111). The data registration module (112) may be the input device of the user (HID) which the user employs to input data or commands, and could be the keyboard of a cellular phone, or a touchpad. The input device of the user (HID) could also be a microphone which detects voice command input, or a camera associated with the interaction system (11) which detects a gesture of the user or implements recognition of characters using OCR (optical character recognition).

Additionally, the human interface device (HID) may be selected from the group comprised of a biometric device, a barcode reader, a facial recognition device or other similar elements known to persons skilled in the art.

In an embodiment of the invention, the interaction system (11) may comprise a visualization device connected to the communications and pairing module (115). By a visualization device is meant any device which can be connected to the computation unit and enables monitoring some video signals sent by the computation unit. In one embodiment of the invention, the visualization device is configured to display alert notifications generated by the verification module (111) such as a text message. This enables notification of the user, for example, when the ignition of the vehicle is enabled or not. Referring to FIG. 1, the security system for vehicles (2) additionally comprises a voice and audio intercommunication module (114) which could be embedded in the communications and pairing module (115) or connected to the communications and pairing module (115).

In a particular embodiment, the voice and audio intercommunication module (114) is configured to send and receive audio and voice data to and from an external device (14) and/or to reproduce or transmit audio and voice data. In another particular embodiment, the voice and audio intercommunication module (114) sends and receives audio and voice signals to and from the communications and pairing module (115) which is charged with processing those audio and voice signals and acquiring some audio on voice data and sending them to an external device (14).

Optionally, the interaction system (11) comprises an orientation system connected to the verification module (111), and the orientation system is charged with identifying or describing the actual physical location of the associated device. In particular, the location system may be selected from among real-time locating systems, GSM localization, and global positioning systems (GPS), among others.

Meanwhile, another aspect of the present invention is to protect the security of the user of the vehicle. One manner of protecting the integrity of the user of the vehicle is to be assured that the user is using the helmet or that the helmet is being used in the correct manner. For this purpose, the security system of the vehicle (2) additionally comprises a device for helmets (13) which enables acquisition of status data of the helmet, which could be whether the user is using the helmet or not, if the user has buckled the helmet, if the user is using the helmet correctly, among other possibilities. The security system of the vehicle (2) with a device for helmets (13) is termed a security system for vehicles and users of vehicles (1).

Referring to FIG. 2, in an embodiment which is comprised by the elements enclosed in the dotted line boxes, the security system for vehicles and users of vehicles (1) may comprise:
a device for helmets (13) configured to be disposed in the helmet of the user, and comprised of:
   a sensor (133) configured to acquire the state of the helmet data (3-1);
   a computation unit (131) connected to the sensor (133) and configured to acquire some validated state of the helmets data (3-3) by means of a verification algorithm which takes into account the state of the helmet data (3-1) and some predetermined state of the helmet data (24) which the computation unit (131) accesses.
   a communications and pairing module (135) connected to the computation unit (131) and configured to generate a pairing and communication link (2-3-1);
an enablement system (12) disposed in a vehicle and comprised of:
   a computation unit (121) configured to generate an activation signal (2-1) on receiving a pairing signal (2-2), some validated state of the helmet data (3-3) and some validated access data (1-1), wherein the computation unit (121) is configured to access some predetermined pairing data (2-3);
   a communications and pairing module (125) connected to the computation unit (121, configured to generate a pairing and communication link (1-2-1) and the pairing signal (2-2), wherein the pairing signal (2-2) is generated when the pairing and communication signal (2-2) is generated on the establishment of the pairing and communication link (1-2-1); in addition the communications and pairing module (125) is configured to establish communication with the communications and pairing module (135) and configured to generate a pairing and communication link (2-3-1) once that connection is established;
   an activator (127) connected to the computation unit (121) and connected to the ignition device of the vehicle (15), wherein the activator (127) is configured to enable the ignition device of the vehicle (15) on receipt of the activation signal (2-1) from the computation unit (121); and
an interaction system (11) connected to the enablement system (12) and the device for helmets (13); and comprised of:
   a communications and pairing module (115) configured to establish communication with the communications and pairing module (125) of the enablement system (12) generating the pairing and communication link (1-2-1) once that link has been established;
   a data registration module (112) configured to generate some configuration data (1-5) by means of a data registry (1-9);
   a verification module (111) connected to the communications and pairing module (115) and to the data registration module (112).

Optionally, the validated state of the helmet data (3-3) are sent to the enablement system (12) via the pairing and communication link (2-3-1).

In the security system for vehicles and users of vehicles (1), the device for helmets (13) is charged with acquiring the state of the helmet data (3-1) to process them and to acquire the validated state of the helmet data (3-3) from the state of the helmet data (3-1) and the predetermined state of the helmet data (24). The validated state of the helmet data (3-3) may be sent to the enablement system (12), since this validated state of the helmet data (3-3) are one of the conditions for the enablement of the ignition device (15). This enables the increased security of the user of the vehicle, bearing in mind that unless they have the helmet on and that it is worn correctly, the vehicle will not start up. Referring to FIG. 2, in one embodiment of the invention, the device for helmets (13) sends the validated state of the helmet data (3-3) to the verification module (111) of the interactions system (11), whereat they are later sent to the enablement system (12). One of the technical effects of not connecting the device for helmets (13) with the enablement system (12) is that it enables the centralization in a single verification element which is the interactions system.

For the acquisition of the state of the helmet data (3-1), the device for helmets (13) comprises the sensor (133). The sensor (133) is a device or set of devices which receives and responds to a signal or stimulus. In a particular embodiment, the sensor (133) monitors, for example, that the user is using the helmet and/or that the user is using the helmet in the correct manner. Also, the sensor (133) may be configured to detect a blow or acceleration that the helmet suffers, for example, in the case of a vehicle crash. The sensor (133) may be selected from the group comprised of a capacitive sensor, a temperature sensor, a contact sensor, an audio sensor, an accelerometer, and a gyroscope.

On the other hand, the device for helmets (13) may be configured to acquire a plurality of conditions of the helmet. The conditions of the helmet could be if the helmet is positioned correctly, that the user has the helmet on, the acceleration of the helmet, among other conditions that may be detected for the helmet. For this purpose, the device for helmets (13) may comprise a plurality of sensors (133), wherein that plurality of sensors (133) is comprised of a sensor (133A) to detect if the buckle of the helmet is adjusted, a sensor (130 3B) to detect the acceleration, and a sensor (133C) that indicates the presence of a head in the helmet.

In a particular embodiment, the sensor (133A) is an audio sensor which detects the sound of the buckle of the helmet and thus determines if the buckle of the helmet is correctly adjusted.

In another embodiment, the sensor (133A) is a contact sensor which detects if the buckle of the helmet is correctly adjusted, by means of a switch which is disposed in the buckle and generates an electrical signal when there is the detection of adjustment of the buckle, that electrical signal is converted to a state of the helmet data (3-1) and is sent to the computation unit (131).

In one embodiment of the invention, the sensor (133B) is an accelerometer which is connected to the external surface of the helmet and sends state of the helmet data (3-1) which corresponds to the acceleration value to the computation unit (131). In addition, the state of the helmet data (3-1) which correspond to the acceleration value are mathematically manipulated to detect angles generated by the movement of the head when the helmet is in use, and this information can be stored in the computation unit (131).

In another particular embodiment, the sensor (133C) is a capacitive sensor which is connected to the interior surface of the helmet and sends state of the helmet data (3-1) which indicates the presence of the existence of a head user to the computation unit (131). In particular, the sensor (133C) which is a capacitive sensor is disposed in a strip or strand which is connected to the interior surface of the helmet.

The computation unit (131) is a hardware element which is a processing unit or a processing module, which is configured to establish communication via the pairing and communication links between one or more computation units to interchange data, commands and/or labels. In a particular embodiment, the computation unit (131) processes the measurements implemented by the sensor (133) to thus obtain the state of the helmet data (3-1). On the other hand, the sensor (133) may contain a processing unit, and in that event the state of the helmet data (3-1) are acquired by this processing unit associated with the sensor (133) and are later sent to the computation unit (131), wherein that processing unit associated with the sensor (133) acquires the state of the helmet data (3-1) using a processing method of the signals or conditioning of the signals.

As previously mentioned, the device for helmets (13) may be charged with acquiring the validated state of the helmet data (3-3), specifically, the computation unit (131) is charged with acquiring the validated state of the helmet data (3-3) from the state of the helmet data (3-1) and the predetermined state of the helmet data (24). Meanwhile, in another embodiment of the present invention of the device for helmets (13), specifically, the computation unit (131) may be charged with acquiring the status of the helmet data (3-1) and these are sent to the interaction system (11) to obtain the status of the helmet data (3-1) thereat, with this as a variant of the security system for vehicles and users of vehicles. In this latter embodiment, the computation unit (131) is configured to execute a processing method of signals of the state of the helmet, and the method of processing is nothing more than a conditioning of the signal which should be understood to be a conversion of the input signal (for example, electrical signal, mechanical signal) to another output signal. In this case, the input signal could be an electrical signal obtained by the sensor (133) and the computation unit (131) converts this input signal to another output signal, which could be a digital signal which in turn is converted into the state of the helmet data (3-1), which are then stored or displayed to the user, depending on needs. Additionally, the security system for vehicles and users of vehicles (1) may have in an embodiment performing those two prior embodiments simultaneously, that is to say, the device for helmets (13) may obtain validated state of the helmet data (3-3) at the same time as acquiring the state of the helmet data (3-1) depending on the nature of the sensor (133) and the computation unit (131).

In this embodiment of the invention which is not illustrated in the figures, wherein the verification module (111) in addition to acquiring some validated access data (1-1), also obtains some validated state of the helmet data (3-3), the security system for vehicles and users of vehicles (1) comprises:
a device for helmets (13) configured to be disposed in the helmet of the user and comprised of:
   a sensor (133) configured to obtain a state of the helmet signal;
   the computation unit (131) connected to the sensor (133) configured to obtain the state of the helmet data (3-1) from the state of the helmet signal; and
   a communications and pairing module (135), connected to the computation unit (131), configured to generate a pairing and communication link (1-3-1);
an enablement system (12) disposed in the vehicle and comprised of:
   a computation unit (121) configured to generate an activation signal (2-1) on receipt of a pairing signal (2-2), some validated state of the helmet data (3-3) and some validated access data (1-1), wherein the computation unit (121) is configured to consult some predetermined pairing data (2-3);
   a communications and pairing module (125) connected to the computation unit (121), configured to generate a pairing and communication link (1-2-1) and the pairing signal (2-2), wherein the pairing signal (2-2) is generated on the establishment of that pairing and communication link (1-2-1);
   an activator (127) connected to the computation unit (121) and connected to an ignition device of the vehicle (15), where the activator (127) is configured to enable the ignition device of the vehicle (15) on receipt of the activation signal (2-1) from the computation unit (121); and
an interaction system (11) connected to the enablement system (12) and the device for helmets (13); and is comprised of:
   a communications and pairing module (115) configured to establish communications with the communications and pairing module (125) of the enablement system (12) generating a pairing and communication link (1-2-1) once that connection has been established; the communications and pairing module (115) is additionally configured to establish communication with the communications and pairing module (135) and configured to generate the pairing and communication link (1-3-1) once that connection is established;
   a data registration module (112) configured to generate some configuration data (1-5) by means of a data registry (1-9);
   a verification module (111) connected to the communications and pairing module (115) and to the data registration module (112);
      wherein the verification module (111) is configured to generate the validated access data (1-1) by means of a verification algorithm which takes into account configuration data (1-5) generated by the data registration module (112) and some predetermined pairing data (2-3);
      wherein the verification module is additionally configured to generate some validated state of the helmet data (3-3) by means of a verification algorithm which takes into account the state of the helmet data (3-1) acquired by the computation unit (131) and some predetermined state of the helmet data (24) accessed via the verification module (111);
      wherein the predetermined pairing data (2-3) are sent to the interaction system (11) via the pairing and communication link (1-2-1) when the computation unit (121) receives the pairing signal (2-2);
      wherein the state of the helmet data (3-1) are sent to the interaction system (11) via the pairing and communication link (1-3-1);
      wherein the validated access data (1-1) and the validated helmet access data (3-3) are sent to the enablement system (12) via the pairing and communication link (1-2-1).

In accordance with that laid out above, the verification module (111) may also be configured to access the predetermined state of the helmet data (24) which may be in the storage module (116).

As previously mentioned, the interaction system (11) may also obtain the validated state of the helmet data (3-3), wherein the interaction system (11) can verify the validated state of the helmet data (3-3) in the verification module (111) in this case, and send them to the enablement system (12) via the pairing and communication link (1-2-1) towards the communication and pairing module (125), to be sent to the computation unit (121) to implement the enablement of the ignition of the vehicle. One of the technical benefits of this verification embodiment is to reduce the processing load of the device for helmets (13) and to centralize the control of the validation of the states in the interaction system (11).

Finally, the computation unit (131), whether it is the one which is solely charged with acquiring the state of the helmet data (3-1) and/or the one which generates the validated state of the helmet data (3-3), may be selected from the group comprised of: microcontrollers, microprocessors, DSCs (Digital Signal Controllers), FPGAs (Field Programmable Gate Arrays), CPLDs (Complex Programmable Logic Devices), ASICs (Application Specific Integrated Circuits), SoCs (System on Chip), PSoCs (Programmable System on Chip) (for example PSOC 4BLE), computers, servers, tablets, cellular phone, intelligent cellular phones, signal generators and computation units, processing units or processing modules known to persons skilled in the art and combinations thereof. In a particular embodiment, the computation unit (131) is a microcontroller.

On the other hand, the computing unit (131) may comprise a storage module (136), wherein the storage module (136) is a hardware element which may be employed to store information or data and which may be accessed by the computation unit (131).

Referring to FIG. 2, the computation unit (131) may have a storage module (136) associated therewith which enable storage of the predetermined state of the helmet data (24) and the validated state of the helmet data (3-1).

The storage modules (116, 126, 136) may be selected from the group comprised of: RAM memory (cache memory, SRAM, DRAM, DDR), ROM memory (flash, cache, hard disks, SSD, EPROM, EEPROM, extractable ROM memory (for example, SD (mini SD, microSD, etc.), MMC (Multimedia Card), CompactFlash, SMC (Smart Media Card), SDC (Secure Digital Card), MS (Memory Stick), among others), CD-ROM, Digital Versatile Disks (DVD) or other optical storage, magnetic cassettes, magnetic tape or any other media which may be employed to store information. Instructions, data structures, or information program modules may be incorporated in the storage modules (116, 126, 136). Some examples of data structures: a text page, a spreadsheet, or a database.

On the other hand, the communications and pairing module (135) is a hardware element coupled with a computation unit, processing unit, or a processing module or server, which is configured to establish communication via the pairing and communication link between one or more computation units or servers to interchange data, commands and/or labels, which should enable the establishment of pairing between elements.

In other words, the communications and pairing module (135) should be capable of establishing pairing with another element to later link those elements. Continuing with FIG. 2, the computation unit (131) is charged with sending the validated state of the helmet data (3-3) obtained from the communications and pairing module (135) and in doing so sends them to the communications and pairing module (125) via the pairing and communication link (2-3-1) and/or may simultaneously also send the state of the helmet data (3-1) (in an embodiment not illustrated in the figures) to the communications and pairing module (115) of the interaction system (11) via the pairing and communication link (1-3-1).

In another particular embodiment, the computation unit (131) sends the validated state of the helmet data (3-3) obtained from the communications and pairing module (135) where they are sent to the communications and pairing module (115) via the pairing and communication link (1-3-1).

In one embodiment of the invention, the communications and pairing module (135) may be configured to generate a pairing signal (3-2), wherein a connection verification may be made which is similar to that implemented by the enablement system (12), wherein a verification is performed on some configuration data, associated with the helmet which are generated by the data registration module (112), and of some predetermined pairing data associated with the helmet which the computation unit (131) accesses. In the same manner as with the enablement system, when the computation unit (131) receives the pairing signal (3-2), it sends the predetermined pairing data associated with the helmet as a response to the interaction system (11). The verification module (111) obtains some valid access data associated with the helmet by means of a verification algorithm which takes into account configuration data associated with the helmet and some predetermined pairing data associated with the helmet. On receipt of the valid access data associated with the helmet, these are sent to the computation unit (131), which is configured to send the validated state of the helmet data (3-3) on receipt of the valid access data associated with the helmet. This provides security to the user in so much as the state of the helmet data (3-1) is only for sending to the interaction system (11) associated with the user.

The communications and pairing module (135) may be selected from the group comprised of a communication component with Bluetooth low energy technology, or a communication component with classic Bluetooth technology, Wi-Fi, radio frequency RFID (Radio Frequency Identification), UWB (Ultra Wide Band), IP telephony, GPRS, Konnex or KNX, DMX (Digital MultipleX), WiMax and equivalent wireless communication technologies known to persons skilled in the art and combinations of those listed above which enable the establishment of a pairing and communication link with another device. On the other hand, the communications and pairing module (135) may be configured from independent modules which perform distinct functions, such that they could be a pairing module and a communications module.

The device for helmets (13) enables the establishment of a voice and audio communication between a third party and the user of the vehicle or between the interaction system (11) and the user of the vehicle. For that purpose and referring to FIGS. 2 and 3, the communications and pairing module (135) additionally comprises an audio and voice intercommunication module (134), that audio and voice intercommunication module (134) may be configured from an audio device (for example, a speaker), an audio sensor (for example a microphone), and audio receptor and an audio transmitter. Additionally, the audio and voice intercommunication module (134) may receive an alert notification, in the form of an alarm, when an anomaly is detected in the helmet and it will be reproduced via, for example, a speaker. The voice and audio intercommunication module (134) may be selected from the group comprised of cellular phones, walkie-talkies, and telephones.

Optionally, the audio and voice intercommunication module (134) sends audio and voice signals to the audio and voice intercommunication module (114). The audio and voice data are sent to the audio and voice intercommunication module (114) via the pairing and communication link (1-3-3).

Referring to FIGS. 2, 3 and 5, the audio and voice intercommunication module (134) obtains and sends some audio and voice data to the audio and voice intercommunication module (114) via the pairing and communication link (1-3-3). This enables the access of the vehicle user to reception of voice and music notifications, and reception and transmission of calls.

The device for helmets (13) is connected with other devices for helmets (13) via their respective voice and audio intercommunication modules (134), which generate a pairing and communication link (3-3-1). In this case, the voice and audio intercommunication modules (134) access the audio and voice data and sends them via the pairing and communication link (3-3-1). This enables easier communication via voice and audio between the driver and a passenger in what could be a two-person vehicle such as a motorcycle.

On the other hand, the device for helmets (13) may comprise a power module (138), which is a device capable of maintaining an electrical potential difference between two or more terminals such as non-rechargeable batteries and the rechargeable batteries which may be selected as an energy source. Referring to FIGS. 2 and 3, in an embodiment of the invention of the power module (138), it is connected with the sensor (133) and a computation unit (131).

In a particular example, the power module (138) is a rechargeable battery, which is selected from the group of rechargeable batteries of lithium ions, for example, LFP batteries, NMC batteries, Li—S batteries, LiPo batteries and other equivalent batteries known to persons skilled in the art. In the same manner, the power module could be substituted by non-rechargeable batteries, like for example, zinc-carbon batteries (dry batteries), zinc chloride, alkaline batteries, lithium batteries, lithium iron disulfide batteries, and other equivalent batteries known to persons skilled in the art.

In one embodiment of the invention, the device for helmets (13) comprises a casing, which houses elements of the device for helmets (13) which needs some type of protection which could be, for example, the computation unit (131).

Referring to FIG. 4, in one embodiment of the invention, the security system for vehicles and users of vehicles (1) comprises an interaction system (11) which is a mobile device. On the other hand, the communications and pairing module (115) comprises a communications component with Bluetooth low energy technology, which sends data to an enablement system (12) disposed in a motorcycle and is connected with a device for helmets (13), wherein the communications and pairing module (135) also comprises a communication component with Bluetooth low energy technology. Comprising this type of communication technology enables the optimization of energy consumption, extending the usage duration of the device.

On the other hand, in another aspect of the present invention, a security system for users of vehicles (3) is described which protects the user of the vehicle in cases wherein the user may have an accident, and in those cases the security system enables the sending of an alert message by the user via the device for helmets (13) directly to a third-party in a rapid manner, or if the user cannot communicate with the third party to report the emergency, for example in the case of the loss of consciousness, the interaction system (11) sends an alert message to a third party.

To implement the latter, in a particular embodiment, the sensor (133) and/or the computation unit (131) of the device for helmets (13) acquires the state of the helmet data (3-1) of the user. Those state of the helmet data (3-1) are verified either by the computation unit (131) and/or by the verification module (111) of the interaction system (11) with respect to the predetermined state of the helmet data (24). This verification enables the detection if the user suffered a serious impact, and if that is the case, the interaction system (11) sends an alert message to a third-party or optionally emits an alarm via an audio and voice intercommunication module (134) for the user, and in the event that there is no response by the interaction system (11) or by the device for helmets (13) the interaction system (11) sends an alert message to a third party on the part of the user.

Referring to FIG. 3, in an embodiment of the invention which is comprised by the elements closed in the dotted point blocks, the security system for users (3) of vehicles which employ helmets comprises:
a device for helmets (13) configured to be disposed in the helmet of a user and comprised of:
   a sensor (133) configured to acquire a state of the helmet data (3-1);
   a computation unit (131) connected to the sensor (133) and configured to acquire some validated state of the helmet data (3-3) by means of a verification algorithm which takes into account the state of the helmet data (3-1) and some predetermined state of the helmet data (24) which the computation unit (131) accesses;
   a communications and pairing module (135) connected to the computation unit (131), configured to generate a pairing and communication link (1-3-1); and
an interaction system (11) connected to the device for helmets (13), wherein the interaction system (11) is comprised of:
   a communications and pairing module (115) configured to establish communication with the communications and pairing module (135) of the device for helmets (13) generating a pairing and communication link (1-3-1) once that connection is established;
   a data registration module (112) configured to generate some configuration data (1-5) by means of a data registry (1-9);
   a verification module (111) connected to the communications and pairing module (115) and to the data registration module (112).

In particular, the verification module (111) is configured to acquire a command to issue an alert (1-6) on receipt of the validated state of the helmet data (3-3) from the computation unit (131). In this particular embodiment, the validated state data (3-3) are sent to the interaction system (11) via the pairing and communication link (1-3-1).

As mentioned earlier in a non-illustrated embodiment, the computation unit (131) may be charged with acquiring the state of the helmet data (3-1) from some state of the helmet signals obtained by the sensor (133). The interaction system (11) receives the validated state of the helmet data (3-3) acquired by the computation unit (131) from the device for helmets (13). In this case, the verification module (111) is additionally configured to verify some validated state of the helmet data (3-3) by means of a verification algorithm which takes into account the state of the helmet data (3-1) acquired by the computation unit (131) and some predetermined state of the helmet data (24) which the verification module accesses (111). Upon acquiring these validated state of the helmet data (3-3), the verification module (111) generates a command to issue an alert (1-6).

This enables the issuing of the alert from the alert generation module (117) to the audio and voice intercommunication module (114) via the pairing and communication link (1-14-1) to an external device (14). This enables the issuing of a voice and audio alert to the cellular phone of a third party.

Referring to FIG. 3, for the generation of alerts once there is the detection of any irregularity, the interaction system (11) comprises a generation of alerts module (117) connected to the verification module (111) and to the communications and pairing module (115), and is configured to generate an alert notification (1-7) from the command to issue an alert (1-6).

On the one hand, the generation of alerts module (117) should be understood to be an element which produces an alert message to be sent to the user of the helmet, a contact or an external system. In one embodiment of the invention, the generation of alerts module (117) is a computation unit which processes the command to issue an alert (1-6) and generates the alert notification (1-7).

As the generation of alerts module (117), a selection may be made from antitheft alarms, fire alarms, emergency text messages, and visual and audio alarms.

In a particular embodiment, the interaction system (11) may receive an alert signal (3-4) from the device for helmets (13) generated by a generation of alerts module (137) and sent via the pairing and communication link (1-3-1).

Once the generation of alerts module (117) generates an alert notification, the audio and voice intercommunication module (114) is configured to send the alert notification (1-7) to an external device (14) associated with the third-party via the audio and voice communication link (1-14-1).

An external device (14) should be understood to be any device which has the capacity to receive an alert notification (1-7). The external device (14) would be a cellular phone or an emergency service, inter alia.

On the other hand, in an embodiment which is not illustrated in the figures, the communications and pairing module (115) is configured to issue an alert command (1-6) to a server, wherein that server is configured to generate and send an alert notification (1-7) to an external device (14) of another user. This facilitates the interaction system (11) having less elements.

A server should be understood to be a device which has a processing unit configured to execute a series of instructions corresponding to steps or stages of methods, routines or algorithms.

Moreover, the server has a communications module which enables establishing a connection with other servers or computation devices.

Moreover, the servers may be mutually connected, and be connected with other computational devices via web service architecture and communicate using communication protocols such as SOAP, REST, HTTP/HTML/TEXT, HMAC, HTTP/S, RPC, SP, and other communications protocols known to persons skilled in the art.

Similarly, the servers mentioned in the description of the present invention may be interconnected via networks such as the Internet, VPN, WAN and other equivalent or similar networks known to persons skilled in the art, and combinations of the same. These same networks may connect with computation units (131) and to the verification module (111) and to one or more servers.

Some of the servers mentioned in the description of the present invention could be virtual servers or physical servers.

Any of the servers of the present invention may comprise a memory module configured to store instructions which on being executed by the server execute part or the totality of one or more steps of any of the methods disclosed here.

In one embodiment of the invention, the communications and pairing method (115) is configured to be connected to a computational network via which an alert notification (1-7) is sent to an external device (14) of another user. A computational network is a set of technical means which enable remote communication between autonomous systems, such as computational devices and servers. Normally, there is transmission of data electromagnetically via diverse media (for example, air, vacuum, copper cable, optical fiber, etc.).

Some non-limiting examples of communications networks are: Internet, WAN and LAN. It can be understood that the methods and systems disclosed herein may employ any type of equivalent communications network known to persons skilled in the art.

On the other hand, the alert notification (1-7) is selected from the group comprising a telephone call, a text message, an email, an audio recording, the location of a cellular phone or combinations of the above.

As previously mentioned, the security system for users of vehicles (3) establishes if the user can be found in any emergency situation, a manner of determining the same is to know if the user suffered a substantial impact. To determine if the user suffered an impact, the sensor (133) obtains some state of the helmet data (3-1) which could be the force to which the helmet was subject, in this case, the sensor (133) could be an accelerometer.

The state of the helmet data (3-1) could be changes in the acceleration of the helmet, temperature of the helmet or distance travelled by the helmet.

In a particular embodiment, the sensor (133) could be a sensor of heart rate, which enables the determination, for example, if the user is suffering a heart attack, or a cardiac variation which puts the user in a vulnerable state. In this case, the sensor (133) could be an external device compatible with the communications technology so that there is communication via the communications and pairing module (135).

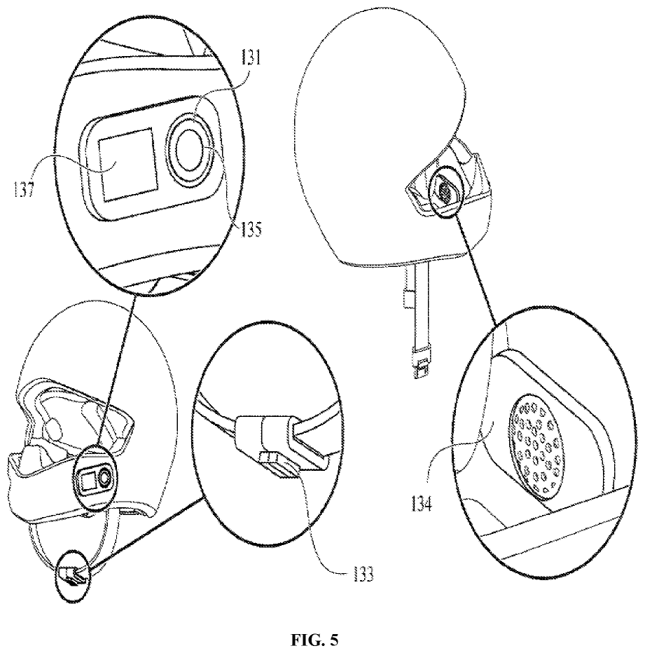

Referring to FIG. 5, the device for helmets (13) is disposed in a helmet, the device comprises a casing disposed on the exterior of the helmet which houses the communications and pairing module (135) connected to a computation unit (131) which comprises a storage module (136) and a casing disposed in the interior of the helmet which houses the voice and audio intercommunication module (134) which is comprised of a microphone and a speaker. On the other hand, the device for helmets (13) comprises a sensor (133) which could be a sensor located in the buckle of the helmet or in the external casing disposed in the interior and detects if the buckle of the helmet is adjusted.

Additionally, the device for helmets (13) comprises a generation of alerts module (137) connected with the computation unit (131), which is configured to generate an alert signal (3-4). That generation of alerts module (137) comprises an input device which could be a button. Referring to FIGS. 2 and 3, the alert signal (3-4) could be sent to the voice and audio intercommunication module (134) or to the communications and pairing module (135), which should then send it to the verification module (111) of the interaction system (11).

Referring to FIGS. 2, 3 and 5, the device for helmets (13) comprises a generation of alerts module (137) connected with the computation unit (131), wherein the generation of alerts module (137) comprises a switch, for example, a button. When the user operates the switch of the generation of alerts module (137), a manual emergency signal (3-4) is generated which is sent to the interaction system (11). In addition, availing of the audio and voice intercommunication module (134), the user can establish communications with an external device or with other nearby devices for helmets (13), to seek help by means of the call.

Any of the embodiments of the security system for users of vehicles (3) which employ a helmet can be embodied in any of the embodiments of the security for vehicles and users of vehicles (1). In this particular embodiment, the verification module (111) of the security for vehicles and users of vehicle system (1) comprises a generation of alerts module (117) connected to the verification module (111) and to the communications and pairing module (115), and is configured to generate an alert notification (1-7) pursuant of a command to issue an alert (1-6), which is received from the same verification module (111).

With the difference systems described above, the present invention implements security methods wherein some data are acquired and are compared with some predetermined data that were established by the user to thus enable actions, such as enable the ignition of the vehicle and/or issue and alert notification to a third party.

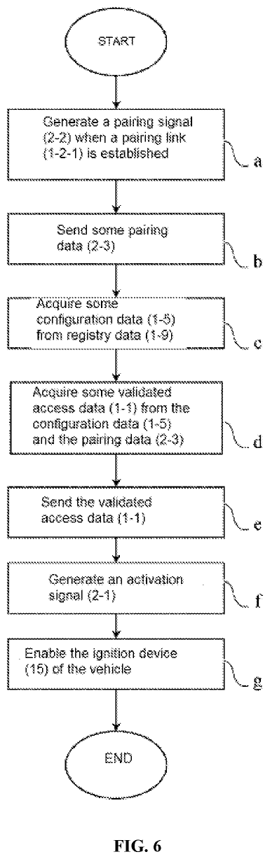

Referring to FIG. 6, in one embodiment of the invention, the security method for vehicles comprises the following steps:
a) generating a pairing signal (2-2) when a pairing and communication link (1-2-1) is established between the communications and pairing module (115) of an interaction system (11) and the communications and pairing module (125) of an enablement system (12) and sending that pairing signal (2-2) to a computation unit (121) of the enablement system (12);
b) sending some predetermined pairing data (2-3), which are accessed by the computing unit (121), to the verification module (111) of the interaction system (11) via the pairing and communication link (1-2-1) on receipt of the pairing signal (2-2);
c) acquiring some configuration data (1-5) by means of a data registration module (112) based on registry data (1-9);
d) acquiring some validated access data at the verification module (111) by means of a verification algorithm which takes into account the configuration data (1-5) and the predetermined pairing data (2-3);
e) sending the validated access data (1-1) to the computation unit (121) via the pairing and communication link (1-2-1);
f) generating an activation signal (2-1) in the computation unit (121) of the enablement system (12) on receipt of the validated access data (1-1); and
g) enable an ignition device (15) of the vehicle by transmitting the activation signal (2-1) to an activator (127) of the enablement system (12) which is connected to the ignition device (15).

In this case, the verification module (111) executes a verification algorithm of some of the configuration data (1-5) that are generated by the interactions system (11) by means of the data registration module (112). In a specific embodiment, the verification algorithm compares the configuration data (1-5) with the predetermined access data (2-3) sent by the enablement system (12) and the verification module (111) generates some validated access data (1-1), only when they coincide, to thus continue with step g). In the event that the configuration data (1-5) do not coincide with the predetermined access data (2-3), there is return to performing the verification of the connection in step a).

Additionally, in the case where the configuration data (1-5) do not coincide with the predetermined access data (2-3), the verification module (111) generates a command to issue an alert, which is sent to the generation of alerts module (117) to generate an alert notification, which is for informing the user.

On the other hand, the verification performed by the interaction system (11) may be performed in either of a passive form or an active form. In the passive form, the user does not have to avail of the interaction system (11), it is sufficient to merely come close to the enablement system (12) to enable the ignition device. This is because the predetermined access data (2-3) and the configuration data (1-5) were previously acquired in the interaction system (11). Specifically, before using the interaction system (11), the user inputs the input data (1-9) to the data registration module (112) to thus obtain the configuration data (1-5), which the verification module (111) can access.

In the same manner, the predetermined access data (2-3) are input to the enablement system (12) so that the computation unit (121) may access them at any time. When the interaction system (11) moves to within a determined distance of the enablement system (12), the verification module (111) performs the verification algorithm without the user needing to implement any action. This passive form of verification avoids the need for the user to perform additional activities to enable the ignition device (15) of the vehicle.

On the one hand, the active form of verification of the interaction system (11) solicits the input of the registration data (1-9) by the user by means of an input device to thus obtain the configuration data (1-5); in the event that the configuration data (1-5) and the predetermined access data (2-3) do not satisfy the conditions of the verification algorithm, the verification module (111) does not send the validated access data (1-1) to the enablement system (12). One of the technical effects of this verification is to prevent a third party which has acquired the interaction system (11) from stealing the vehicle, insomuch as the enablement system (12) would not enable the ignition device (15) because the validated access data (1-1) would not be received.

Optionally, the security method of the present invention could additionally execute a verification algorithm to see if the ignition device (15) of the vehicle is enabled. The computation unit (121) would execute a verification algorithm wherein a determination is made as to whether the ignition device (15) is found to be disabled.

If the computation unit (121) verifies that the ignition device (15) is enabled, another verification algorithm of pairing is executed, which enables the verification of pairing between the enablement system (12) and the interaction system (11), which initiates a time lapse counter in the event that there is no connection between those two elements.

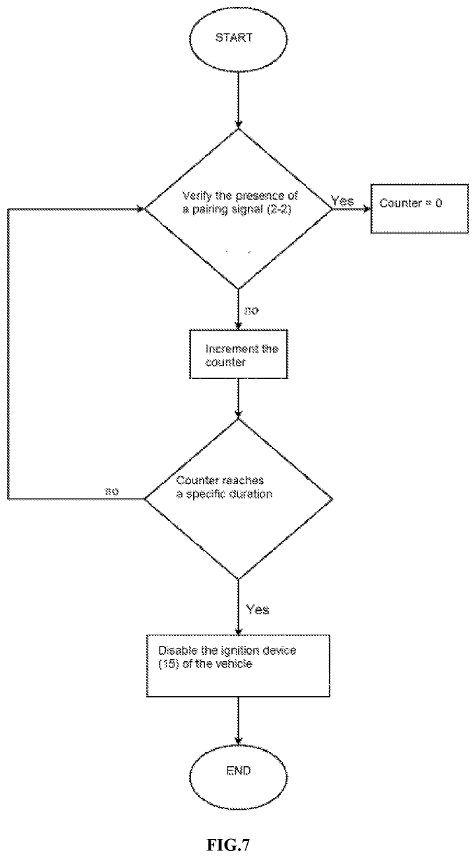

Referring to FIG. 7, the algorithm of the verification of pairing is illustrated which consists of the verification of the presence of any pairing signal (2-2) at the computation unit (121), in the event that this pairing signal (2-2) is found in the computation unit, then the time lapse counter is reset to zero and the ignition device of the vehicle (15) continues to be enabled. On the other hand, if there is no pairing signal (2-2) present, the time lapse counter continues to increase.

Simultaneously, the verification module (111) performs a verification of the existence of a pairing and communication link (1-2-1) and in the event that no pairing and communication link (1-2-1) exists, the verification module (111) generates a command to issue an alert which is sent to the alert generation module (117). As a result, the generation of alert module (117) generates an alert notification, which could, for example, be a text message which is displayed to the user by means of a visualization device associated with the interaction system (11), or could be an audible message which is transmitted to the user by means of the audio on voice intercommunication module (114).

On the other hand, the computation unit (121) could execute a disablement verification algorithm to determine if the ignition device of the vehicle (15) should be disabled, and this is performed by determining if the time-lapse counter has reached a count greater than a predetermined duration, for example 90 seconds.

Referring to FIG. 7, the disablement verification algorithm would compare the time-lapse count with the predetermined time-lapse duration and then verify if the time-lapse count is greater than the predetermined duration. If the time-lapse count is greater than the predetermined duration, then the computation unit (121) stops transmitting the activation signal (2-1) to the activator (127) and the ignition device of the vehicle (15) is disabled. In the event that the time count is not greater than the predetermined duration, then the computation unit (121) returns to the execution of the verification algorithm of the link. Additionally, the verification module (111) could send a notification to an external device (14).

Additionally, in the event that there is a device for helmets (13) present, the security method could perform additional verifications of other conditions, such as, conditions associated with the helmet, that is to say for example, if the user is using the helmet and/or if it is worn correctly. One of the technical effects of the present invention is the enablement of the vehicle on completion of the conditions associated with the device for helmets (13).

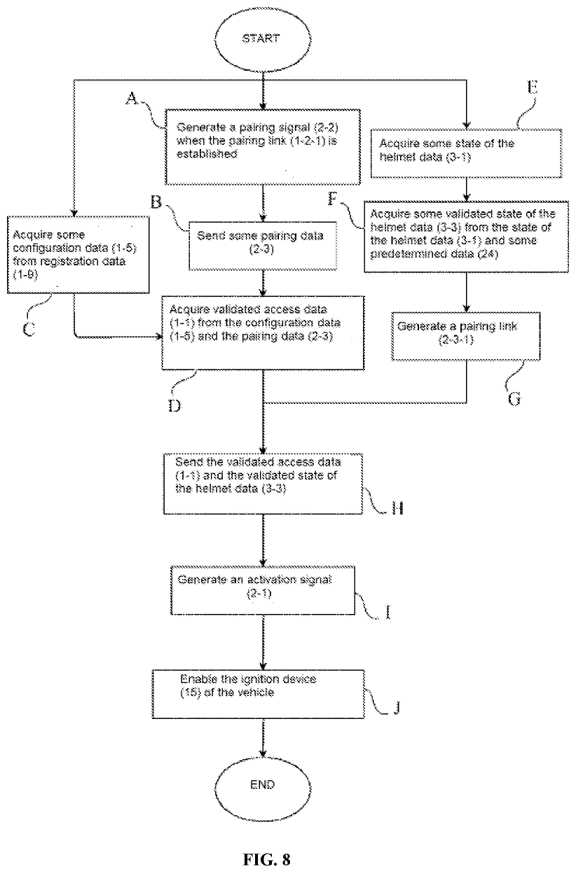

On the other hand, referring to FIG. 8, in one embodiment of the invention, the security method for vehicles and users that use a helmet comprises the following steps:
A) generating a pairing signal (2-2) in a communications and pairing module (125) of the enablement system (12) when a pairing and communication link (1-2-1) is established between the communications and pairing module (125) and the communications and pairing module (115) of the interaction system (11) and sending the generated pairing signal (2-2) to the computation unit (121) of the enablement system (12);
B) sending some predetermined pairing data (2-3), which the computation unit (121) accesses, to the verification module (111) of the interaction system (11) via the pairing and communication link (1-2-1) on receipt of the pairing signal (2-2);
C) acquiring some configuration data (1-5) by means of the data registration module (112) based on registration data (1-9);
D) acquiring some validated access data (1-1) at the verification module (111) by means of a verification algorithm which takes into account the configuration data (1-5) generated by the data registration module (112); and the predetermined pairing data (2-3);
E) acquiring data of the state of the helmet (3-1) from a sensor (133) in the device for helmets (13);
F) acquiring some validated state of the helmet data (3-3 at the computation unit by means of a verification algorithm which takes into account the state of the helmet data (3-1) and the predetermined state of the helmet data (24) which the computation unit (131) accesses;
G) generating a pairing and communication link (2-3-1) between the communications and pairing module (125) and the communications and pairing module (135) of the device for helmets (13);
H) sending the validated access data (1-1) via the pairing and communication link (1-2-1) and the validated state of the helmet data (3-3) via the pairing and communication link (2-3-1) to the computation unit (121);
I) generating an activation signal (2-1) at the computation unit (121) from the validated access data (1-1) and the validated state of the helmet data (3-3); and
J) enabling the ignition device (15) of the vehicle by transmitting the activation signal (2-1) to an activator (127) of the enablement system (12) which is connected to the ignition device (15).

In the same manner that the valid access data (1-1) are acquired, the computation unit (131) executes a verification algorithm to acquire some valid access data (3-3) and the verification algorithm contemplates the state of the helmet data (3-1) acquired by the sensor (133) and the predetermined state of the helmet data (24). The verification algorithm can compare the acquired state of the helmet data (3-1) with the predetermined state of the helmet data which the computation unit (131) can access and which the computation unit generates some validated state of the helmet data (3-3) only when the data coincide, to thus proceed with step G). In the event that the acquired state of the helmet data (3-1) do not coincide with the predetermined state of the helmet data (24), there is a return to step E).

On the other hand, in an embodiment which is not illustrated in the figures, the verification module (111) can execute a verification algorithm to acquire some valid access data (3-3), the verification algorithm takes into account the state of the helmet data (3-1) acquired in this particular embodiment by the computation unit of the device for helmets (13) based on a processing method of signals which inputs the state of the helmet signal acquired by the sensor (133) and the predetermined state of the helmet data (24).

Optionally, the verification algorithm would compare the acquired state of the helmet data (3-1) with the predetermined state of the helmet data (24) which can be accessed by the verification module (111) and the verification module (111) generates some validated state of the helmet data only when the data coincide, to thus proceed with step G) in the event that the input state of the helmet data (3-1) do not coincide with the predetermined state of the helmet data (24), there is a return to repeat step E). Additionally, in the event that the state of the helmet data (3-1) do not coincide with the predetermined state of the helmet data (24), the verification module (111) generates a command to issue an alert, which is sent to the alert generation module (117) to generate an alert notification, which is displayed to the user by means of a visualization device associated with the interaction system (11).

In general terms, it is important to emphasize that the steps of the different methods are not necessarily in a linear sequence, which is to say that there may be some steps which can be executed in parallel, such as the step of the generation of the pairing signal (2-2) and the step of acquiring some state of the helmet data (3-1), these steps can happen at the same time or one before the other without this affecting the results of the methods of the present invention.

Continuing with FIG. 8, it is apparent that in some embodiments of the invention the steps C, B and E are not sequential, but in this particular case occur in parallel, with the result that it is not important that one step occurs before or after another.

In one particular embodiment, in which the enablement system (12) comprises a backup system (122), the generation of an activation signal (2-1) can occur in two situations, either because the computation unit (121) receives the validated access data (1-1) and the validated state of the helmet data (3-3), or because the computation unit (121) validates some backup data (21) that could be stored in the storage module (126) with some validated backup data (20) obtained by means of the backup system (122).

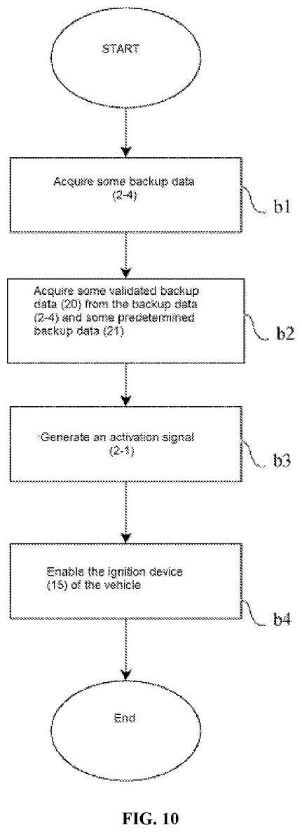

Referring to FIG. 10, the enablement system (12) comprises a backup system (126), such that the security method for vehicles comprises the following steps:
b1) acquiring some backup data (2-4) at a backup system (122) based on the input of authentication which the user inputs in an input device of the backup system (122);
b2) acquiring some validated backup data (20) at the computation unit (121) by means of a verification algorithm which takes into account the backup data (2-4) and some predetermined backup data (21);
b3) generating an activation signal (2-1) at the computation unit (2-1) based on the validated backup data (20);
b4) enabling the ignition device (15) of the vehicle by transmitting the activation signal (2-1) to the activator (127) which is connected to the ignition device (15).

In this case, the computation unit (121) executes a verification algorithm of some backup data (2-4) which should be input to the enablement system (12) by means of the input device of the backup system (122). Optionally, the verification algorithm would compare the backup data (2-4) acquired with the predetermined backup data (21) stored in the computation unit (121) and generating some validated backup data (20) only when they are found to coincide at the computation unit, to thus proceed with step b4). In the event that the backup data (2-4) do not coincide with the predetermined backup data, there is a return to step b1). Optionally, the security method for vehicles utilizes the steps b1) to b4) when the pairing signal (2-2) has not been generated. This could occur when the user loses the interaction system (11) or is not enabled because of discharge of the battery, resulting in the enablement system (12) executing the steps b1) to b4) without the need for the pairing signal (2-2).

In one particular embodiment, the verification algorithm of the backup data may comprise the following steps when the backup data (2-4) do not coincide with the predetermined backup data (21), then the computation unit (121) comprises a counter, denominated the enablement counter.

In the event that the backup data (2-4) do not coincide with the predetermined backup data (21), the computation unit (121) increases the value of the enablement counter by one, and later verifies that the enablement counter is less than or equal to a predetermined number of attempts. In the event that the enablement count is greater than the predetermined number of attempts, the activation signal (2-1) to enable the ignition device (15) is not sent, and the user of the vehicle is notified. In the event that the enablement count is less than the predetermined number of attempts, there is a return to performing step b1).

On the other hand, and as was mentioned in the security system for users of vehicles (3), there is consideration of verification of some conditions to determine if the driver has suffered an accident and if the user is unconscious, and in the event that the user is not conscious, the system would send an alert notification (1-7) to a third-party.

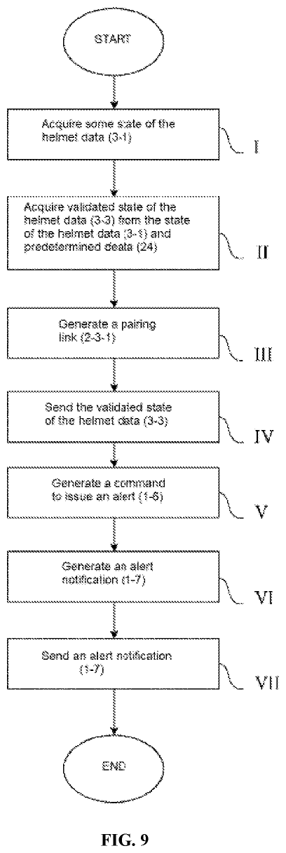

Referring to FIG. 9, in one embodiment of the invention, the security method for users of vehicles comprises the following steps:
I) acquiring some state of the helmet data (3-1) from the sensor (133) of the device for helmets (13);
II) acquiring some validated state of the helmet data (3-3) at the computation unit (131) of the device for helmets (13), by means of a verification algorithm which takes into account the state of the helmet data (3-1) and some predetermined state of the helmet data (24) which the computation unit (131) accesses,
III) generating a pairing and communication link (1-3-1) between the communications and pairing module (115) of the interaction system (11) and the communications and pairing module (135) of the device for helmets (13);
IV) sending the validated state of the helmet data (3-3) via the pairing and communication link (1-3-1) to a verification module (111) of the interaction system (11);
V) generating a command to issue an alert (1-6) in the interaction system (11) based on the validated state of the helmet data (3-3);
VI) generating an alert notification (1-7) by means of a generation of alerts module (117) of the interaction system (11) based on the command to issue an alert (1-6); and
VII) sending an alert notification (1-7) from the communications and pairing module (115) to the external device (14) of another user.

Nevertheless, the method may have an optional step which does not occur in parallel with respect to the other steps, wherein the user manually sends an emergency signal from the device for helmets (13) via an accessory alert generation module (137) to the verification module (111), wherein a command to issue an alert (1-6) is generated and is sent to the alert generation module (117), to generate an alert notification (1-7), and that alert notification (1-7) is sent to a third party via the communications and pairing module (115). This helps the user, who while conscious, does not have the capacity to write a message, or wishes to send it as soon as possible. For these types of situations, the automatic system enables sending an alert message rapidly, by means of a button or a voice signal via virtual assistants such as: Siri, Alexa, Google Assistant, among others.

In another embodiment of the invention, step II) comprises a sub-step in which the computing unit (131) generates an alert notification on acquiring the validated state of the helmet data (3-3) which is sent to the audio and voice intercommunication module (134), in the event that the alert notification is audio data. Optionally, the generated alert notification is sent via the communications and pairing module (135) to the interaction system (11) so that this is reproduced by the audio and voice intercommunication module (114) when the notification is audio data or displayed in a visualization device when it is an array of characters configuring a message. In one embodiment, the generated alert notification is sent simultaneously to the audio and voice intercommunication module (134) and to the interaction system (11). After sending the generated notification, a window of time is opened for the user to indicate some registration data in the data registration module (112), those registration data would indicate if the user feels OK and there is a return to repeating step I). However, in the event of that the user does not input the registration data indicating that he feels okay, step III) proceeds.

On the other hand, in the case of step II), the computing unit (131) executes a verification algorithm of some state of the helmet data (3-1) which are acquired by means of the sensor (133) of the device for helmets (13). In a particular embodiment, the verification algorithm compares the acquired state of the helmet data (3-1) with the predetermined state of the helmet data which can be consulted by the computation unit (131) and the computation unit generates some validated state of the helmet data (3-3) only when there is coincidence, to thus proceed with step III). In the event that the acquired state of the helmet data (3-1) do not coincide with the predetermined state of the helmet data (24), there is return to performing step I).

In another aspect of the invention, the sensor (133) could be an accelerometer which measures the acceleration to which the helmet is subject. The verification algorithm could compare the acquired state of the helmet data (3-1) corresponding to the acceleration of the helmet with the predetermined state of the helmet data (24), which in this case corresponds to a predetermined acceleration stored in the storage module (126). That predetermined acceleration determines a threshold which enables identification of the gravity of the impact which the user of the vehicle suffered.

In a particular embodiment, there is consideration as to whether the acceleration of the helmet is greater than 3.8 [g], (with g being the gravity), in which case the user has suffered a severe impact, and the predetermined state of the helmet data (24) in this case correspond to an acceleration of 3.8 g. In this case, the verification algorithm would compare the acquired state of the helmet data (3-1), corresponding to a certain acceleration, with the predetermined state of the helmet data (24), if the state of the helmet data (3-1) corresponding to the measured acceleration of the helmet corresponds to a value greater than 3.8 g, then the validated state of the helmet data (3-3) are generated and are sent to the verification module (111) to thus proceed with step V). In the event that the state of the helmet data (3-1) correspond to an acceleration which is less than 3.8 G, there is a return to step I).

In another embodiment of the invention, the security method for users of vehicles comprises the following steps: acquiring a state of the helmet signal from a sensor (133) in the device for helmets (13) from a processing method of signals; acquiring some state of the helmet data (3-1) at the computation unit (131) of the device for helmets (13) based on a processing method of signals which inputs the state of the helmet; generating a pairing and communication link (1-3-1) between the communications and pairing module (115) of an interaction system (11) and a communications and pairing module (135) of the device for helmets (13); sending the state of the helmet data (3-1) via the pairing and communication link (1-3-1) to a verification module (111) of the interaction system (11); acquiring some validated state of the helmet data (3-3) by means of a verification algorithm which takes into account the input state of the helmet (3-1) and predetermined data of the state of the helmet (24) which is accessed by the verification module (111); generating a command to issue an alert (1-6) at the verification module (111) from the valid state of the helmet data (3-3); generating an alert notification (1-7), by means of a generation of alerts module (117) of the interaction system (11), from the command to issue an alert (1-6); sending an alert notification (1-7) at a communications and pairing module (115) to an external device (14) of another user. In this particular embodiment, the sensor (133) acquires a state of the helmet signal and the computing element (131) processes that state of the helmet signal to acquire the state of the helmet data (3-1), this state of the helmet data (3-1) is sent to the interaction system (11) wherein the verification module (111) generates the validated state of the helmet data (3-3).

One of the technical effects of the invention is that, in the case of a collision, the interaction device (11) sends a notification to an external device (14) on automatically receiving an alert command.

### EMBODIMENTS

### Embodiment 1

An embodiment of the security system for vehicles (2) was designed to enable the ignition of the vehicle, and the specific characteristics of that security system for vehicles (2) are the following:

For this particular embodiment, the vehicle is a motorcycle in which the enablement system (12) is disposed. In this case, the computation unit (121) is a PSOC 4 BLE which is located within the motorcycle and is connected to the power system (battery and power circuits) of the motorcycle.

That computation unit (121) comprises the following modules:
an ARM CORTEX M0 processor;
a storage module (126) which is a flash memory integrated with the computation unit (121);

Also, the enablement system (12) has a communications and pairing module (125) which is a Bluetooth Low Energy module connected to the computation unit (121) processor, and has at least a range of 15 m.

In addition, the enablement system (12) has an activator (127) connected to the ignition device of the vehicle (15) which is the starting system of the motorcycle in this case. In particular, in this embodiment, the activator (127) is an electro-server whose activation enables the functioning of the gas tank of the motorcycle.

The enablement system (12) also comprises a sensor (123) which transmits information about a characteristic of the vehicle; velocity, acceleration or angle, to the computation unit (121) which is sent to the interaction system (11), employing the communications and pairing module (125), to the communications and pairing module (115) of the interaction system (11).

Finally, the enablement system (12) has a backup mechanism (122) which is an authentication device comprised of a biometric sensor, connected to the computation unit (121) wherein the activator is enabled (127).

On the other hand, the interaction system (11) is a cellular phone, tablet, computer, HMI, and in this case the interaction system (11) comprises a verification module (111) which is the processor of the interaction system, a communications and pairing module (115) which is a Bluetooth communications module (BLE, EDR) with a range of 25 m.

Also, the interaction system (11) has a storage module (116) which is the storage memory of the cellular phone and the interaction system (11) has a data registration module (112) where in the data registry is input (1-9). In this case the data registration module (112) is a touchpad.

In addition, the interaction system (11) comprises a generation of alerts module (117) which is a part of the processor wherein an alert is produced when a command (1-6) is received, and that notification is sent to the external device by the communications and pairing module (115), which is connected to an external network to send the alert notification (1-7) to the external device (14).

In this case, a first test was implemented wherein the user approached the motorcycle without their cellular phone and tried to start up the motorcycle in vain. In the second test, the user with their cellular phone approached the motorcycle, and when the mobile phone came within the range of the communications and pairing module (125) of the enablement system (12) which is located in the motorcycle, the user tried to implement the start-up of the motorcycle, and in this case the motorcycle started up without problems. In this particular embodiment, the enablement system (12) implemented a passive enablement, which is to say that previously, the user entered registration data (1-9) via the data registration module (112) to the cellular phone, which in this case is the VIN of the motorcycle, by means of this registration data (1-9) configuration data (1-5) is generated which is stored in the storage module (116). Also, this VIN number of the motorcycle corresponds to the predetermined data (2-3) which was stored in the storage module (126) of the computation unit (121).

Also, this VIN number of the motorcycle corresponds to a predetermined data (2-3) which was stored in the storage module (126) of the computer unit (121).

When the cellular phone was near the motorcycle, the configuration data (1-5) was compared with the predetermined data (2-3), and a determination was reached that they were the same and some validated access data (1-1) were sent to the enablement system (12). The enablement system (12) enables the ignition of the motorcycle on receiving the validated access data (1-1).

In this case, a test was performed wherein the user approached a motorcycle without their cellular phone and the attempt to start the motorcycle failed. In a subsequent test, the user input a key via the backup system (122) and once the key was validated based on that stored in the module (126), the computation unit (121) generated the activation signal (2-1), with which the activator (127) enabled the ignition of the motorcycle.

### Embodiment 2

The system of embodiment 1 executes the following method to prevent the ignition of a motorcycle by an unknown party. Before initiating the method, the communication and pairing module (125) located in the motorcycle and the communications and pairing module (115) of the cellular are found searching for a possible pairing link. When the cellular phone comes within the range of the communications and pairing module (125), a pairing and communication link (1-2-1) is generated and a pairing signal (2-2) is sent to the computation unit (121). This pairing is enabled by means of a Bluetooth, Wi-Fi standard IEEE 802.15, IEEE 802.11 communications protocol compatible with Bluetooth technology 4.0 and 5.0, and Wi-Fi 2.4 GHz.

The computation unit (121) sends some predetermined data (2-3) via the pairing and communication link (1-2-1) to the verification module (111) or the cellular processor. The predetermined data (2-3) are packaged and they are sent by means of Bluetooth Low Energy protocol.

The verification module (111) acquires some validated access data (1-1) from the predetermined data (2-3) and some configuration data (1-5) generated in the data registration module (112) based on the registration data (1-9), and in this case the input of the registration data (1-9) is performed beforehand and the configuration data (1-5) is stored in the storage module (116). In this embodiment, the registration data (1-9) and the predetermined data corresponding to a registration number of the vehicle (VIN) associated with the motorcycle. Specifically, some validated access data (1-1) are obtained by applying a verification module which is based on comparing the predetermined data (2-3) with some configuration data (1-5) and if they coincide, some validated access data (1-1) are sent to the computation unit (121). For example, the verification algorithm is stored in the storage memory of the verification module (111) and is executed therein.

The computation unit (121) generates an activation signal (2-1), on receipt of these validated access data (1-1), which is an electrical signal and sends it to the activator (127). The ignition device (15) of the motorcycle is enabled when the activator (127) receives the activation signal (2-1).

With the system and methods of embodiments 1 and 2, the demonstration of a considerable increase in the antitheft security of the motorcycle is enabled, since the motorcycle cannot be started without the cellular phone of the owner of the motorcycle.

### Embodiment 3

A security system for drivers and vehicles (1) was designed to enable the start up the vehicle and to acquire information of the helmet of the user/driver, wherein the specific characteristics of that system for drivers and vehicles (1) are as follows:

In this particular embodiment, the vehicle is a motorcycle, in which the enablement system (12) is disposed. In this case, the computation unit (121), which is a PSOC 4 BLE, is located within the motorcycle, is connected to the power system (battery and power circuits) of the motorcycle.

That computation unit (121) comprises the following modules:
an ARM CORTEX M0 Processor;
a storage module (126) which is a FLASH memory integrated with the computation unit (121).

Also, the enablement system (12) has a communication and pairing module (125) which is a Bluetooth Low Energy module integrated with the computation unit (121), and has a minimum range of 15 m.

Moreover, the enablement system (12) has an activator (127) connected to the ignition device of the vehicle (15) which in this case is the starter of the motorcycle. In particular, the activator (127) in this embodiment is an electrical relay. Moreover, the enablement system (12) comprises a sensor (123) which transmits information about the characteristics of the vehicle to the computation unit (121) and which is sent to the interaction system (11), using the communications and pairing module (125), to the communications and pairing module (115) of the interaction system (11).

Finally, the enablement system (12) has a backup system (122) which is a backup device configured from a biometric sensor, connected to the computation unit (121), which is employed to enable the activator (127).

On the other hand, the interaction system (11) is a cellular phone, and in this interaction system (11) comprises a verification module (111) which is the processor of that cellular phone, a communications and pairing module (115) which is a Bluetooth low energy communications module with a range of 22 m.

Also, the interaction system (11) has a storage module (116) which is the memory of a cellular phone and the interaction system (11) has a data registration module (112) wherein registration data (1-9) is input. In this case, the data registration module (112) is a touchpad used by the user to input data or commands.

It also comprises a generation of alerts module (117) which is connected to the verification module (111). The interaction system (11) utilizes the communications and pairing module (115) to send an alert notification generated by the generation of alerts module (117). Furthermore, the interaction system (11) comprises an audio and voice intercommunication module (114), connected to the audio and voice intercommunication module (134) of a device for helmets (13), wherein the user/driver can access voice calls and reception of audio messages.

Finally, the device for helmets (13) can be found installed in the helmet of the user of the motorcycle, that device for helmets (13) is an accessory which comprises a sensor (133) in the interior thereof which is an accelerometer, a computation unit (131) which is the PSOC 4 BLE and a storage module (136) which is a flash memory integrated in the computation unit (131). The computation unit (131) is connected to a communications and pairing module (135) which is an integrated Bluetooth low energy module with a minimum range of 22 m. Moreover, the system for helmets (13) comprises a generation of alerts module (137) configured to generate an alert. It also comprises a voice and audio intercommunication module (134) which can establish intercommunication with another device for helmets (13). Moreover, the voice and audio intercommunication module can receive information from the interaction system (11) via the voice and audio intercommunication system (114).

In this case, a first test was implemented wherein the user approached the motorcycle without their cellular phone and attempted to start up the motorcycle but failed.

In a second test, the user approached the motorcycle with their cellular phone, as soon as the cellular phone came within the range of the communications and pairing module (125) of the enablement system (12) which is located in the motorcycle, the user attempted to implement the start-up of the motorcycle but without putting on (putting the helmet on their head) or buckling the security helmet, and in this case the motorcycle did not start up.

In the third test, the user approached the motorcycle with their cellular phone, and once the cellular phone was within range of the communications and pairing module (125) of the enablement system (12) located in the motorcycle, the user attempted to implement the start-up of the motorcycle with the helmet worn correctly and buckled, and in this case the motorcycle started up.

In this final test, the device for helmets (13) acquires some validated state of the helmet data (3-3) which indicates that the helmet was located in the correct form and properly buckled and sent them to the enablement system (12).

In this particular embodiment, the enablement system (12) implements a passive enablement, which is to say that the user previously input a registration data (1-9) via the data registration module (112) of the cellular phone which in this case was the VIN number of the motorcycle, configuration data (1-5) stored in the storage module (116) was generated by means of this registration data (1-9). Moreover, this VIN number of the motorcycle corresponds to a predetermined data (2-3) that was stored in the storage module (126).

When the cellular phone was near the motorcycle, the configuration data (1-5) was compared with the predetermined data (2-3), and after determining that they were identical, some validated access data (1-1) were sent to the enablement system (12).

### Embodiment 4

The system of embodiment 3 executed the following method to enable/disable the start-up of a motorcycle. Before initiating the method, the communications and pairing module (125) located in the motorcycle and the communications and pairing module (115) of the cellular phone continually search for a possible pairing link. When the cellular phone comes within the range of the communications and pairing module (125), a pairing and communication link (1-2-1) is generated and a pairing signal (2-2) is sent to the computation unit (121). The computation unit (121) send some predetermined data (2-3 via the pairing and communication link (1-2-1) to the verification module (111) or the processor of the cellular phone.

The verification module (111) acquires some validated access data (1-1) from the predetermined data (2-3) and some configuration data (1-5) generated in the data registration module (112) from a registration data (1-9), and the input of the registration data in this case (1-9) was performed previously and the configuration data (1-5) is stored in the storage module (116). In this embodiment, the registration data (1-9) and the predetermined data correspond to the registration number of the vehicle (VIN) associated with the motorcycle. Specifically, the validated access data (1-1) are acquired by applying a verification algorithm which is based on comparing the predetermined data (2-3) with some configuration data (1-5) and if they coincide, some validated access data (1-1) are sent to the computation unit (121). The computation unit (121) accesses the pairing data stored in the storage module (126) which is the flash memory associated with the computation unit (121). For example, the verification algorithm is stored in the storage memory (116) of the verification module (111).

On the other hand, the device for helmets (13) simultaneously acquires some valid state of the helmet data (3-3) from a state of the helmet data (3-1), which the sensor (133) acquires, and predetermined state of the helmet data (24) stored in the storage module (136) of the computation unit (131).

This embodiment has a plurality of sensors (133) which are comprised of a sensor (133A) which detects if the buckle is adjusted, a sensor (133B) which detects the acceleration of the helmet and a sensor (133C) which indicates if the user is wearing the helmet.

Specifically, the sensor (133A) is a contact sensor which detects if the buckle of the helmet is correctly adjusted. Similarly, the sensor (133B) is an accelerometer which is connected to the external surface of the helmet. Similarly, the sensor (133C) is a capacitive sensor which is connected to the internal surface of the helmet, and sends a signal which indicates the presence of the head of the user.

The values generated by the sensors (133A, 133B, 133C) are processed by the processor of the computation unit (131), which generates this state of the helmet data (3-1) based on the state signals.

Specifically, the valid state of the helmet data (3-3) are acquired by applying the verification algorithm which is based on comparing the predetermined data (24) with the state of the helmet days (3-1) and if they coincide, some valid state of the helmet data are generated (3-3).

To enable the sending of the validated state of the helmet data (3-3), a pairing and communications link (2-3-1) is generated between the device for helmets (13) and the enablement system (12) when the device for helmets (13) comes within the range of the communications and pairing module (125). This pairing is implemented by means of a Bluetooth communication protocol under the IEEE 802.15 standard which is compatible with Bluetooth technology 4.0 and 5.0. Once the pairing and communication link (2-3-1) is acquired, the valid state of the helmet data (3-3) are sent to the computation unit (121) via the pairing and communication link (2-3-1).

The computation unit (121), on receiving the validated access data (1-1) and the validated state of the helmet data (3-3), generates an activation signal (2-1) which is an electrical signal and sends it to the activator (127). The ignition device (15) of the motorcycle is enabled when the activator (127) receives the activation signal (2-1).

With the system and method of embodiments 3 and 4, there is a demonstrable and considerable increase in the antitheft security of the motorcycle as well as incrementing the physical integrity of the user of the motorcycle, since the motorcycle will not start up without the presence of the cellular phone of the user and without correctly buckling the helmet.

### Embodiment 5

A security system for users (3) of vehicles which use helmets was designed to detect the correct use of the helmet and accident conditions. The specific characteristics of that security system for users (3) of vehicles which use helmets are as follows:

In this particular embodiment the helmet is a motorcycle helmet, which has the device for helmets (13) disposed therein. In this case, the computation unit (131) is a PSOC 4 BLE which is located on the internal and external surface of the helmet.

The computation unit (131) comprises the following modules:
Processor: ARM CORTEX M0;
Storage module (136): FLASH memory;
Generation of alerts module (137): a button which generates an electrical signal and sends it to the processor.

The device for helmets (13) also has a communications and pairing module (135), which is an integrated Bluetooth Low Energy module with the computation unit (131) processor and has a range of 22 m.

Moreover, the device for helmets (13) has an audio and voice intercommunication module (134) which is a classic Bluetooth module and is connected to another audio and voice intercommunication module of another device for helmets (13). The audio and voice intercommunication module (134) also receives information via the pairing and communication link (1-3-3) of the audio and voice intercommunication module (114) of the interaction system (11).

The device for helmets (13) comprises a sensor (133) which is an accelerometer which is connected to the external surface of the helmet and sends an acceleration value to the computation unit (131). Moreover, the acceleration value is mathematically manipulated to detect angles generated by the movement of the head when the helmet is in use. It also comprises a generation of alerts module (137) configured to send an alert signal. Moreover, the voice and audio intercommunication module (134) can receive information from the interaction system (11) via the voice and audio intercommunication system (114).

On the other hand, the device for helmets (13) comprises a power module (138) which is a battery, which is charged with supplying adequate levels of energy to the computation unit (131), to the audio and voice intercommunication module (134 and to the sensor (133).

Moreover, it comprises an interaction system (11) which is a cellular phone, and in this case the interaction system (11) comprises a verification module (111) which is the processor of that cellular phone, a communications and pairing module (115) LE which is a Bluetooth communications module with a range of 22 m. Moreover, the interaction system (11) has a storage module (116) which is the memory of the cellular phone and the interaction system (11) has a data registration module (112) wherein registration data (1-9) is input. In this case, the data registration module (112) is an input device of the user (HID) which the user employs to input data and commands, such as the keyboard of a cellular phone or a touch panel. The input device of the user (HID) could also be a microphone, or the camera of a cellular phone, which detects as input a voice command, or recognizes characters by using OCR. It also comprises a generation of alerts module (117) which is connected to the verification module (111). The interaction system (11) utilizes the communications and pairing module (115) to send an alert notification generated by the generation of alerts module (117) to an external device (14).

In this case, a first test was implemented wherein the user simply put the helmet on his head without buckling it, and the validated state of the helmet data (3-3) acquired correspond to not having correctly buckled the helmet. In this case, the generation of alerts module (117) sends an alert notification (1-7) to an external device (14), indicating that the helmet is not correctly buckled.

In a second test, the user merely buckled the helmet, without putting it on their head, the acquired validated state of the helmet data (3-3) correspond to not having located the helmet correctly. In this case, the generation of alerts module (117) sends an alert notification (1-7) to an external device (14) indicating that the helmet is not being worn correctly.

Later, a third test was implemented wherein the subject of the test (a mannequin) is wearing the helmet and it is correctly buckled, followed by experimentally inducing a collision of the test subject. In this case, some validated status data (3-3) were generated which corresponded to the detection of an impact, and once the validated state data (3-3) were generated, the generation of the alert module (117) sent an alert notification (1-7) to the external device (14) indicating that a crash was detected.

Similarly, a fourth test was implemented wherein the user activated the generation of alerts module (137) by pressing the button, and an alert notification was sent (1-7) in the form of a text message from the interaction system (11) to the external device (14).

A fifth test of intercommunication between two devices for helmets (13) was implemented, wherein there was only one device for helmets which was paired, and in this case the intercommunication was not possible because there was no pairing between the voice and audio intercommunication modules (134) of the two devices for helmets (13).

Finally, a sixth test was implemented of intercommunication between two devices for helmets (13), wherein both devices for helmets were paired, and in this case the intercommunication was possible because pairing between the voice and audio intercommunication modules (134) of the two devices for helmets (13) existed.

### Embodiment 6

In the system of embodiment 5, the following method for detecting impact in the device for helmets (13) is executed wherein there is an ongoing search for pairing and communication links (1-3-1) between the communications and pairing module (135) and the communications of pairing module (115) of the interaction system (11). When the device for helmets (13) falls within the range of the communications and pairing module (115), the pairing and communications link (1-3-1) is established. Thereafter, the computation unit (131) acquires some state of the helmet days (3-1) from the sensor (133) and validates them with the predetermined state of the helmet data (24) of the storage unit (136). In the third test, the detected state of the helmet data (3-1) exceeded the predetermined helmet data (24), because the computation unit (131) generated some validated state of the helmet data (3-3), which were sent to the verification module (111). The verification module (111) and on receiving the validated state of the helmet data (3-3) generated a command to issue an alert (1-6), which was sent to the generation of alerts module (117), whereon an alert notification was generated (1-7) which in this case was an audio recording with the danger message and this was sent to the communications and pairing module (115). Subsequently, the communications and pairing module (115) sends the alert notification (1-7) to the external device (14) via the pairing and communication link (1-14-11). Finally, the alert notification (1-7) was heard at the external device (14).

With the system and method of the embodiments 4 and 5, the increased physical integrity of the user of the motorcycle could be demonstrated, since an alert was sent to a third-party when the acceleration exceeded the threshold, which indicated that the helmet suffered an impact.

### Embodiment 7

In this particular embodiment, a backup system (122) was added to embodiment 2 which is comprised of an input device which is a mechanical encoder with a luminous display. The backup system (122) enables the input of an authentication input via the input device, wherein backup data is generated.

Before the test of the backup system, the interaction system (11) should have connected to the enablement system (12) to charge the predetermined values therein such as the predetermined backup data (21). A test was performed wherein the user approached the motorcycle without a cellular phone, an attempt was made to start the motorcycle but failed, but there was a later input of authentication to the backup system (122). On inputting that authentication input to the backup system (122), some backup data (2-4) were generated and sent to the computation unit (121) and the computation unit compared them to the predetermined backup data (21) stored in the computation unit (121). Having verified that the backup data (2-4) were identical to the predetermined backup data (21), the enablement system (12) generated some validated backup data (20) and the ignition of the motorcycle was enabled.

With this backup system (122), there is an advantage over the system of embodiment 2, wherein there is the demonstration of flexibility if the user discharges their cellular phone or loses it, the user could still start up the motorcycle.

### Glossary

Enablement system (12): is an electronic, mechanical or electromechanical system which physically enables the ignition of the vehicle.

Predetermined access data (2-3): is an ordered array of bits which is produced when some numerical or alphanumeric characters, or personalized backup steps proposed by the user to execute an activity are input.

Vehicle data (2-5): is an ordered array of bits which is produced and processing of a signal associated with the characteristic of the vehicle.

Interaction system (11): is a device which comprised as a minimum a processor, wherein an application which enables the registration of users, devices, and interaction there between is installed and executed.

Registration data (1-9): is an array of characters in part by the user by means of an input device to produce some configuration data (1-5), this array of characters may configure any type of personal information or vehicle information.

Configuration data (1-5): is an ordered array of bits produced from the registration data input by the user.

Validated access data (1-1): is an ordered array of bits produced when a determined condition is validated, wherein that condition may be that the configuration data (1-5) and the predetermined data (2-3) are the same.

Alert notification (1-7): is an array of characters (text message) or some audio data (recording) which travels therein towards a user or external contact.

Command to issue of an alert (1-6): is an ordered array of bits produced and acquiring some state of the helmet data (3-3) at the verification module (111).

Device for helmets (13): is a device for acquisition of data which is located in helmets.

State of the helmet data (3-1): is an ordered array of bits produced used by the processing of a signal supplied by a sensor associated with a helmet.

Validated state of the helmet data (3-3): Is an ordered array of bits produced when and determined condition is validated, that condition could be that the state of the helmet data (3-1) are the same as the predetermined state of the helmet data (24).

Predetermined state of the helmet data (24): is an ordered array of bits produced corresponding to information that the user inputs and against which the state of the helmet data (3-1) are validated.

Backup system (122): is an element which is in receipt of an array of numerical, alphanumerical characters, or a security pattern, and sends it to the computation unit (121) to be processed.

Input of authentication: is an array of characters input by the user via an input device of the backup system.

Backup data (2-4): is the binary information produced from the input of authentication input by the user.

Predetermined backup data (21): is an ordered array of bits produced which corresponds to the input of authentication (array of characters) which is input by the user (for example, a number, credential or pattern), which are stored and are validated in respect of the backup data (2-4).

Validated backup data (20): is an ordered array of bits produced when a predetermined condition is validated, that condition could be that the backup data (2-4) and the predetermined backup data (21) are the same.

Verification algorithm: is a set of defined and non-ambiguous instructions or rules, which are ordered and finite which enable the solution of a problem, execute a computation, process data and complete other tasks and activities.

Signal: is the representation of a physical magnitude which is interpreted by the computation unit.

Communication and pairing link: is a digital channel to transmit and receive every type of data between two mutually linked devices.

Pairing signal: is a signal generated by a communication and pairing module when there is the detection of a proximal element to verify if a pairing with this element is possible.

It should be understood that the present invention is not limited to the embodiments described and illustrated, such that the possible variations and modifications which do not depart from the spirit of the invention exist, defined by the following claims.

1. A security system of vehicles (2) comprising:
an enablement system (12) disposed in the vehicle and comprised of:
a computation unit (121) configured to generate an activation signal (2-1) on receipt of a pairing signal (2-2) and some validated access data (1-1), wherein the computation unit (121) is configured to access some predetermined pairing data (2-3);
a communications and pairing module (125) connected to the computation unit (121), and configured to generate a pairing and communication link (1-2-1) and the pairing signal (2-2), wherein the pairing signal (2-2) is generated on the establishment of the pairing and communication link (1-2-1);
an activator (127) connected to the computation unit (121) and connected to an ignition device of the vehicle (15), wherein the activator (127) is configured to enable the ignition device of the vehicle (15) on receipt of the activation signal (2-1) from the computation unit (121); and
an interaction system (11) connected to the enablement system (12) and comprised of:
a communication and pairing module (115) configured to establish communication with the communications and pairing module (125) of the enablement system (12) generating the pairing and communication link (1-2-1) once the connection is established;
a data registration module (112) configured to generate some configuration data (1-5) by means of a data registry (1-9);
a verification module (111) connected to the communications and pairing module (115) and to the data registration module (112).
wherein the verification module (111) is configured to generate the validated access data (1-1) by means of a verification algorithm which takes into account configuration data (1-5) generated by the data registration module (112) and some predetermined pairing data (2-3);
wherein the predetermined pairing data (2-3) are sent to the interaction system (11) via the pairing and communication link (1-2-1) when the computation unit (121) receives the pairing signal (2-2);
wherein the validated access data (1-1) are sent to the enablement system (12) via the pairing and communication link (1-2-1).

2. The system in accordance with claim 1, wherein the configuration data (1-5) are found stored in the storage module (116) of the verification module (111).

3. The system in accordance with claim 1, wherein the predetermined pairing data (2-3) are found stored in the storage module (126) of the computation module (121).

4. The system in accordance with claim 1, wherein the data registration module (112) comprises an input device which is configured to input the registration data (1-9).

5. The system in accordance with claim 1, wherein the interaction system (11) comprises a generation of alerts module (117) connected to the verification module (111) and to the communications and pairing module (115), and is configured to generate an alert notification (1-7) on receipt of a command to issue an alert (1-6) from the verification module (111).

6. The system in accordance with claim 5, wherein the communications and pairing module (115) is configured to generate an alert notification (1-7) to an external device (14).

7. The system in accordance with claim 6, wherein the communications and pairing module (115) is configured to be connected to a computational network via which an alert notification (1-7) is sent to an external device (14) of another user.

8. The system in accordance with claim 1, wherein the communications and pairing module (115) is configured to issue a command to issue an alert (1-6) to a server configured to generate and send an alert notification (1-7) to an external device (14).

9. The system in accordance with claim 1, wherein the enablement system (12) comprises at least one sensor (123) configured to measure a characteristic of the vehicle.

10. The system in accordance with claim 1, wherein the enablement system (12) comprises a backup system (122) with an input device, the backup system (122) is configured to receive the input of authentication, generate some backup data (2-4) and send some backup data (2-4) to the computation unit,
wherein the computation unit (121) is configured to acquire some validated backup data (20) by means of a verification algorithm which takes the backup data (24) and some predetermined backup data (21) which the computation unit (121) accesses into account, and wherein the computation unit (121) is additionally configured to generate the activation signal (2-1) on acquiring the validated backup data (20).

11. The system in accordance with claim 10, wherein the input device of the backup system (122) is selected from the group comprised of the knob of a potentiometer, a mechanical encoder with a luminous indicator, a user interface with digital buttons, an interface with mechanical buttons, a mouse, trackball, touchpad, pointing device, joystick, biometric reader or combinations of the above.

12. A security system for vehicles and users of vehicles (1) comprising:
a device for helmets (13) configured to be disposed in the helmet of the user and comprised of:
a sensor (133) configured to acquire some data of the state of the helmet (3-1) or to acquire a state of the helmet signal;
a computation unit (131) connected to the sensor (133) configured to acquire some validated state of the helmet data (3-3) by means of a verification algorithm which takes the state of the helmet data (3-1) and some predetermined state of the helmet data (24) which the computation unit (131) access into account or to acquire the state of the helmet data (3-1) from the state of the helmet signal;
a communications and pairing module (135), connected to the computation unit (131), configured to generate a pairing and communication link (1-3-1);
an enablement system (12) disposed in the vehicle and comprised of:
a computation unit (121) configured to generate an activation signal (2-1) on receipt of a pairing signal (2-2), some validated state of the helmet data (3-3) and some validated data (1-1), wherein the computation unit (121) is configured to access some predetermined pairing data (2-3);
a communications and pairing module (125) connected to the computation unit (121), configured to generate a pairing and communication link (1-2-1) and the pairing signal (2-2), wherein the pairing signal (2-2) is generated on the establishment of said pairing and communication link (1-2-1) or said communications and pairing module (125) is additionally configured to establish communication with the communications and pairing module (135) and is configured to generate the pairing and communication link (2-3-1) on the establishment of said connection;
an activator (127) connected to the computation unit (121) and connected to an ignition device of the vehicle (15), wherein the activator (127) is configured to enable the ignition device of the vehicle (15) on receipt of the activation signal (2-1) from the computation unit (121); and
an interaction system (11) connected to the enablement system (12) and the device for helmets (13); and comprised of:
a communications and pairing module (115) configured to establish communications with the communications and pairing module (125) of the enablement system (12) generating a pairing and communication link (1-2-1) once said connection has been established; the communications and pairing module (115) is additionally configured to establish communication with the communications and pairing module (135) and configured to generate the pairing and communication link (1-3-1) once said connection is established or said communications and pairing module (115) is additionally configured to establish communications with the communications and pairing module (135) and is configured to generate a pairing and communication link (1-3-1) on the establishment of said connection;
a data registration module (112) configured to generate some configuration data (1-5) by means of a data registry (1-9);
a verification module (111) connected to the communications and pairing module (115) and to the data registration module (112);
wherein the verification module (111) is configured to generate the validated access data (1-1) by means of a verification algorithm which takes into account configuration data (1-5) generated by the data registration module (112) and some predetermined pairing data (2-3);
wherein the verification module is additionally configured to generate some validated state of the helmet data (3-3) by means of a verification algorithm which takes into account the configuration data (1-5) generated by the data registration module (112) and some predetermined pairing data or is additionally configured to generate some validated state of the helmet data (3-3) by means of a verification algorithm which takes into account the state of the helmet data (3-1) acquired by the computation unit (131) and some predetermined state of the helmet data (24) accessed via the verification module (111);
wherein the predetermined pairing data (2-3) are sent to the interaction system (11) via the pairing and communication link (1-2-1) when the computation unit (121) receives the pairing signal (2-2);
wherein the validated access data (1-1) are sent to the enablement system (12) via the pairing and communication link (1-2-1);
wherein the state of the helmet data (3-1) are sent to the enablement system (12) via the pairing and communication link (1-3-1), or the valid helmet access data (3-3) are sent to the enablement system (12) via the pairing and communication link (1-2-1) and the state of the helmet data (3-1) are sent to the interaction system (11) via the pairing and communication link (1-3-1).

13. The system in accordance with claim 12, wherein the device for helmets (13) comprises a generation of alerts module (137) configured to generate an alert signal (3-4).

14. The system in accordance with claim 12, wherein the device for helmets (13) comprises an audio and voice intercommunication module (134) configured to establish communication with an audio and voice intercommunication module (134) of another device for helmets (13).

15. The system in accordance with claim 12, wherein the configuration data (1-5) are found stored in the storage module (116) of the verification module (111).

16. The system in accordance with claim 12, wherein the predetermined pairing data (2-3) are found stored in the storage module (126) of the computation unit (121).

17. The system in accordance with claim 12, wherein the data registration module (112) comprises an input device which is configured to input registry data (1-9).

18. The system in accordance with claim 12, wherein the interaction system (11) comprises a generation of alerts module (117) connected to the verification module (111) and to the communications and pairing module (115), and configured to generate an alert notification (1-7) on receipt of a command to issue an alert (1-6) generated by the verification module (111) on receipt of the validated state of the helmet data (3-3).

19. The system in accordance with claim 18, wherein the communications and pairing module (115) is configured to send the alert notification (1-7) to an external device (14).

20. The system in accordance with claim 19, wherein the communications and pairing module (115) is configured to be connected to a computational network via which an alert notification is sent to an external device (14).

21. The system in accordance with claim 12, wherein the communications and pairing module (115) is configured to send a command to issue an alert (1-6) generated by the verification module (111) on receipt of the validated state of the helmet data (3-3) to a server, wherein said server is configured to generate and send an alert notification (1-7) to an external device (14).

22. The system in accordance with claim 12, wherein the enablement system (12) comprises at least one sensor (123) configured to measure a characteristic of the vehicle.

23. The system in accordance with claim 12, wherein the enablement system comprises a backup system (122) which has an input device, and the backup system (122) is configured to receive the input of authentication, generate some backup data (2-4) and send said backup data (2-4) to the computation unit (121),
wherein the computation unit (121) is configured to acquire some validated backup data (20) by means of a verification algorithm which takes into account to some backup data (2-4) and some predetermined backup data (21) which the computation unit (121) accesses, and wherein the computation unit (121) is additionally configured to generate the activation signal (2-1) and acquiring the validated backup data (20).

24. The system in accordance with claim 23, wherein the input device of the backup system (122) may be selected from the group comprised of the dial of a potentiometer, the user interface with digital buttons, and interface with mechanical buttons, a mouse, trackball, touchpad, pointing device, joystick, or combinations of the above.

25. The system in accordance with claim 12, wherein the interaction system (11) comprises an audio and voice intercommunication module (114) configured to establish a communication with the device for helmets (13) and connecting with an audio and voice intercommunication module (134).

26. The system in accordance with claim 12, wherein the sensor (133) may be selected from the group comprised of a capacitive sensor, a detection of buckling sensor, an accelerometer, a gyroscope, and a combination of the above.

27. A security system for users (3) of vehicles which employ helmets comprises:
a device for helmets (13) configured to be disposed in the helmet of a user and comprised of:
a sensor (133) configured to acquire some state of the helmet data (3-1);
a computation unit (131) connected to the sensor (133) and configured to acquire some validated state of the helmet data (3-3) by means of a verification algorithm which takes into account the state of the helmet data (3-1) and some predetermined state of the helmet data (24) which the computation unit (131) accesses or to acquire the state of the helmet data (3-1) from the state of the helmet signal;
a communications and pairing module (135) connected to the computation unit (131), configured to generate a pairing and communication link (1-3-1); and
an interaction system (11) connected to the device for helmets (13), wherein the interaction system (11) is comprised of:
a communications and pairing module (115) configured to establish communication with the communications and pairing module (135) of the device for helmets (13) generating a pairing and communication link (1-3-1) once said connection is established;
a data registration module (112) configured to generate some configuration data (1-5) by means of a data registry module (1-9);
a verification module (111) connected to the communications and pairing module (115) and to the data registration module (112),
wherein the verification module (111) is configured to generate a command to issue an alert (1-6) on receipt of the validated state of the helmet data (3-3) from the computation unit (131) or is configured to generate some validated state of the helmet data (3-3) by means of a verification algorithm which takes into account the state of the helmet data (3-1) acquired by the computation unit (131) and some predetermined state of the helmet data (24) accessed via the verification module (111) and generates the command to issue an alert (1-6) once the validated state of the helmet data (3-3) have been generated;
wherein the validated state of the helmet data (3-3) or the state of the helmet data (3-1) are sent to the interaction system (11) via the pairing and communication link (1-3-1).

28. The system in accordance with claim 27, wherein the device for helmets (13) comprises a generation of alerts module (137) configured to generate an alert signal (3-4).

29. To system in accordance with claim 27, wherein the device for helmets (13) comprises an audio and voice intercommunication module (134) configured to establish a communication with the audio and voice intercommunication module (134) of another device for helmets (13).

30. The system in accordance with claim 27, wherein the interaction system (11) comprises a generation of alerts module (117) connected to the verification module (111) and to the communications and pairing module (115), and configured to generate an alert notification (1-7) on receipt of a command to issue an alert (1-6).

31. The system in accordance with claim 30, wherein the communications and pairing module (115) is configured to send the alert notification (1-7) to an external device (14).

32. The system according to claim 31, wherein the communications and pairing module (115) is configured to be connected to a computational network via which an alert notification (1-7) is sent to an external device (14) of another user.

33. The system in accordance with claim 27, wherein the communications and pairing module (115) is configured to send the command to issue an alert (1-6) to a server, wherein said server is configured to generate and send out an alert notification (1-7) to an external device (14) of another user.

34. The system in accordance with claim 27, wherein the interaction system (11) comprises an audio and voice intercommunication module (114) configured to establish a communication with the device for helmets (13) via an audio and voice intercommunication module (134).

35. The system in accordance with claim 27, wherein the sensor (133) may be selected from the group comprised of a capacitive sensor, a buckling detection sensor, an accelerometer, and a gyroscope.

36. The system according to claim 27, wherein the sensor (133) is an accelerometer.

37. A security method for vehicles which comprises:
a) generating a pairing signal when a pairing and communication link (1-2-1) is established between the communications and pairing module (115) of the interaction system (11), and the communications and pairing module (125) of an enablement system (12), and sending said pairing signal (2-2) to a computation unit (121) of the enablement system (12);
b) sending some predetermined pairing data (2-3), which the computation unit accesses, to the verification module (111) of the interaction system (11) via the pairing and communication link (1-2-1), on receipt of the pairing signal (2-2);
c) acquiring some configuration data (1-5) by means of a data registration module (112), from a data registry (1-9);
d) acquiring some validated access data (1-1) at the verification module (111), by means of a verification algorithm which takes into account the configuration data (1-5) and the predetermined pairing data (2-3);
e) sending the validated access data (1-1) to the computation unit (121) via the pairing and communication link (1-2-1);
f) generating an activation signal (2-1) at the computation unit (121) of the enablement system (12) on receipt of the validated access data (1-1); and
g) enabling the ignition device (15) of the vehicle, by transmitting the activation signal (2-1) to an activator (127) of the enablement system which is connected to the ignition device.

38. The method according to claim 37, wherein the following stages are executed after stage a), when no pairing signal (2-2) is received:
b1) acquiring some backup data (2-4) at a backup system (122) based on the input of authentication which the user inputs in an input device of the backup system (122);
b2) acquiring some validated backup data (20) at the computation unit (121) by means of a verification algorithm which takes into account the backup data (2-4) and some predetermined backup data (21) which the computation unit accesses;
b3) generating an activation signal (2-1) at the computation unit (2-1) based on the validated backup data (20); and
b4) enabling the ignition device (15) of the vehicle by transmitting the activation signal (2-1) to the activator (127) which is connected to the ignition device (15).

39. A security method for vehicles and users that use a helmet comprising:
A) generating a pairing signal (2-2) in a communications and pairing module (125) of the enablement system (12) when a pairing and communication link (1-2-1) is established between the communications and pairing module (125) and a communications and pairing module (115) of the interaction system (11) and sending the generated pairing signal (2-2) to the computation unit (121) of the enablement system (12);
B) sending some predetermined pairing data (2-3), which the computation unit (121) accesses, to the verification module (111) of the interaction system (11) via the pairing and communication link (1-2-1) on receipt of the pairing signal (2-2);
C) acquiring some configuration data (1-5) by means of the data registration module (112) based on registration data (1-9);
D) acquiring some validated access data (1-1) at the verification module (111) by means of a verification algorithm which takes into account the configuration data (1-5) generated by the data registration module (112); and the predetermined pairing data (2-3);
E) acquiring some data of the state of the helmet (3-1) from a sensor (133) in the device for helmets (13) or the state of the helmet signal;
F) acquiring some validated state of the helmet data (3-3 at the computation unit by means of a verification algorithm which takes into account the state of the helmet data (3-1) and the predetermined state of the helmet data (24) which the computation unit (131) accesses and acquiring by means of the computation unit (131) the state of the helmet data (3-1) from the processing of signals method which has the state of the helmet signal input thereto;
G) generating a pairing and communication link (2-3-1) between the communications and pairing module (125) and the communications and pairing module (135) of the device for helmets (13) or a pairing and communication link (1-3-1) between the communications and pairing module (135) and the communications and pairing module (115);
H) sending the validated access data (1-1) via the pairing and communication link (1-2-1) and the validated state of the helmet data (3-3) to the computation unit (121) And sending the validated state of the helmet data (3-3) to the computation unit (121), wherein the validated state of the helmet data (3-3) when obtained by the verification module (111) are sent to the computation unit (121) via the pairing and communication link (1-2-1) or when the validated state of the helmet days (3-3) are acquired by the computation unit (131) they are sent to the computation unit (121) via the pairing and communication link (1-3-1);
I) generating an activation signal (2-1) at the computation unit (121) from the validated access data (1-1) and the validated state of the helmet data (3-3); and
J) enabling the ignition device (15) of the vehicle by transmitting the activation signal (2-1) to an activator (127) of the enablement system (12) which is connected to the ignition device (15);
wherein the validated state of the helmet data (3-3) acquired by the verification module (111) are obtained by means of a verification algorithm which takes into account the state of the helmet data (3-1) acquired by the computation unit (131) and sent by the pairing and communication link (1-3-1) to the verification module (111) and some predetermined state of the helmet data (24) accessed via the verification module (111).

40. The methods in accordance with claim 39, where after this step A), wherein if the pairing signal (2-2) is not received, the following steps are executed;
b1) acquiring some backup data (2-4) at a backup system (122) based on the input of authentication which the user inputs in an input device of the backup system (122);
b2) acquiring some validated backup data (20) at the computation unit (121) by means of a verification algorithm which takes into account the backup data (2-4) and some predetermined backup data (21);
b3) generating an activation signal (2-1) at the computation unit (2-1) based on the validated backup data (20); and
b4) enabling the ignition device (15) of the vehicle by transmitting the activation signal (2-1) to the activator (127) which is connected to the ignition device (15).

41. A security method for users of vehicles which comprises the following steps:
I) acquiring some state of the helmet data (3-1) from the sensor (133) of the device for helmets (13) or a state of the helmet signal;
II) acquiring some validated state of the helmet data (3-3) at the computation unit (131) of the device for the helmets (13), by means of a verification algorithm which takes into account the state of the helmet data (3-1) and some predetermined state of the helmet data (24) which the computation unit (131) accesses, or the state of the helmet data (3-1) from a processing method of signals wherein the state of the helmet signal is input thereto;
III) generating a pairing and communication link (1-3-1) between the communication and pairing module (115) of the interaction system (11) and the communications and pairing module (135) of the device for helmets (13);
IV) sending the validated state of the helmet data (3-3) via the pairing and communication link (1-3-1) to a verification module (111) of the interaction system (11);
V) generating a command to issue an alert (1-6) in the interaction system (11) based on the validated state of the helmet data (3-3) sent by the device for helmets (13) and/or generated by the verification module (111) by means of a verification algorithm which takes into account the state of the helmet data (3-1) accessed by the computation unit (131) and some predetermined state of the helmet data (24) accessed via the verification module (111);
VI) generating an alert notification (1-7) by means of a generation of alerts module (117) of the interaction system (11) based on a command to issue an alert (1-6); and
VII) sending an alert notification (1-7) from the communications and pairing module (115) to an external device (14) of another user.

42. The method in accordance with claim 41, wherein a command to issue an alert (1-6) is generated in stage VI) if there is the detection of a manual emergency signal (3-4) sent from the generation of alarms module (137) of the device for helmets (13).
